(19) United States
(12) Patent Application Publication
(10) Pub. No.: US 2018/0336732 A1
(43) Pub. Date: Nov. 22, 2018

(54) AUGMENTED REALITY TASK IDENTIFICATION AND ASSISTANCE IN CONSTRUCTION, REMODELING, AND MANUFACTURING

(71) Applicant: Michael J. Schuster, Shorewood, IL (US)

(72) Inventor: Michael J. Schuster, Shorewood, IL (US)

(21) Appl. No.: 15/979,998

(22) Filed: May 15, 2018

Related U.S. Application Data
(60) Provisional application No. 62/506,809, filed on May 16, 2017.
(60) Provisional application No. 62/556,611, filed on Sep. 11, 2017.

(51) Int. Cl. G06T 19/00; G06Q 10/06; G06Q 10/08

(52) U.S. Cl. CPC G06T 19/006; G06Q 50/04; G06Q 10/0875; G06Q 10/063118

(57) ABSTRACT

Disclosed are various embodiments for augmented reality task identification and assistance in construction, manufacturing, and home remodeling. According to various embodiments, an augmented reality system includes a remote computing environment and an augmented reality device, where the remote computing environment is employed to identify tasks for an operator to perform to complete a project. The tasks may be sequentially displayed in an augmented reality session and the environment may be augmented to facilitate performance of the tasks by an operator.

### CROSS-REFERENCE TO RELATED APPLICATIONS

This application claims priority to U.S. Provisional Patent Application No. 62/506,809 entitled “AUGMENTED REALITY TASK IDENTIFICATION AND ASSISTANCE IN CONSTRUCTION, REMODELING, AND MANUFACTURING, filed May 16, 2017, and U.S. Provisional Patent Application No. 62/556,611 entitled “AUGMENTED REALITY TASK IDENTIFICATION AND ASSISTANCE IN PICTURE FRAMING AND HANGING,” filed Sep. 11, 2017, the contents of both being incorporated by reference in their entirety herein.

### FIELD OF THE TECHNOLOGY

The present invention relates to augmented reality (AR), remote data processing, programmatic image recognition, and object detection.

### BACKGROUND

Augmented reality (AR) relates to the process of modifying or augmenting a real-world view of an environment using a device, such as a smartphone or augmented reality eyeglasses. For example, a video feed of an environment can be altered to impose computer-generated images in various portions of the environment shown in the video feed, thereby “augmenting” the environment. Augmented reality devices may include a smartphone, a tablet, or a wearable device, such as eyeglasses having a display, a camera, and processing circuitry, where the display is positioned in front of or near eyes of the wearing user. The processing circuitry adjusts an image or a video feed captured by the camera and imposes computer-generated images or audio in the environment captured by the camera.

Similarly, mixed reality (MR) includes the merging of real and virtual worlds to produce new environments and visualizations where physical and digital objects co-exist and interact in real time. Mixed reality takes place not only in the physical world or the virtual world, but includes a mix of reality and virtual reality, encompassing both augmented reality and augmented virtuality via immersive technology.

### BRIEF SUMMARY OF THE INVENTION

Disclosed are various embodiments for augmented reality task identification and assistance in construction and manufacturing. According to various embodiments, an augmented reality system includes a remote computing environment and an augmented reality device, where the remote computing environment is employed to identify tasks for an operator to perform to complete a project. The tasks may be sequentially displayed in an augmented reality session and the environment may be augmented to facilitate performing the tasks.

Additionally disclosed are various embodiments for augmented reality task identification and assistance in picture framing and hanging. According to various embodiments, an augmented reality system includes a remote computing environment and an augmented reality device, where the remote computing environment is employed to identify tasks for an operator to perform to complete a project where on or more picture frames or other items are hung on a wall. The project may include determining that each picture frame is level, centered, or spaced properly relative to another item hung on the wall.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a networked environment that includes a computing environment and an augmented reality device forming an augmented reality system according to various embodiments of the present disclosure.

FIG. 2 is a drawing of an augmented reality session performed in a smartphone to obtain desired project parameters according to various embodiments of the present disclosure.

FIG. 3 is a drawing of an augmented reality session that imposes or overlays a graphical representation of a completed project according to various embodiments of the present disclosure.

FIG. 4 is a drawing of an augmented reality session that imposes or overlays a graphical representation of a task to complete according to various embodiments of the present disclosure.

FIG. 5 is a drawing of an augmented reality session that imposes or overlays virtual lines on an item to be cut or modified according to various embodiments of the present disclosure.

FIG. 6 is a drawing of an augmented reality session that imposes or overlays a guidance line and an item location in an environment according to various embodiments of the present disclosure.

FIG. 7 is a drawing of an augmented reality session that detects a presence of required materials to complete a task or project according to various embodiments of the present disclosure.

FIG. 8 is a drawing of an augmented reality session that detects a hand gesture to change light fixtures or other items shown as augmented features according to various embodiments of the present disclosure.

FIG. 9 is a flowchart illustrating one example of functionality implemented as portions of the augmented reality system of FIG. 1 according to various embodiments of the present disclosure.

FIGS. 10A-10C are drawings of an augmented reality session that identifies a shape of a tile to be installed according to various embodiments of the present disclosure.

FIG. 11 is a schematic block diagram that provides one example illustration of a computing environment employed in the networked environment of FIG. 1 according to various embodiments of the present disclosure.

FIG. 12 is a schematic block diagram that provides one example illustration of an augmented reality device employed in the networked environment of FIG. 1 according to various embodiments of the present disclosure.

FIGS. 13A-13C are drawings of an augmented reality session that identifies a contour of trim to be matched according to various embodiments of the present disclosure.

FIGS. 14A-14G are drawings of an augmented reality session that assists an operator with locating where to place, leveling, centering, spacing, and performing similar tasks in association with one or more picture frames.

FIGS. 15A-15B are drawings of an augmented reality session in which artwork shown in a picture frame is replaced with other artwork using augmented features imposed in an augmented environment.

FIG. 16 is a drawing of an augmented reality session in which landscaping features are augmented in a natural environment to perform landscaping projects using an augmented environment.

### DETAILED DESCRIPTION

The present disclosure relates to augmented reality (AR) or mixed reality (MR) task identification and assistance for hanging artwork, photographs, wall decals, wallpaper, picture frames, and related items. Augmented reality systems include those that programmatically modify or “augment” a real-world view of an environment using a suitably configured computing device. For instance, a video feed captured by a camera is shown in a display of an augmented reality device, such as a smartphone or augmented reality eyeglasses. Sound or graphics may be added to an environment, or the appearance of the environment shown on the display of the augmented reality device may be modified to alter the perception of the environment for a user.

With the advent of augmented reality, many potential improvements are possible in the field of construction, manufacturing, remodeling, and related industries. For instance, augmented reality systems may be able to assist those with limited skill or expertise in performing a difficult or once impossible task. Thus, the augmented reality systems described herein are beneficial for reducing required skill or expertise, minimizing labor time, optimizing use of materials, and other benefits in construction, manufacturing, and related industries, as will be appreciated. Additionally, embodiments described herein provide for the remote network-based storage of project data. Although an augmented reality device may be purchased, leased, or rented at a fixed price, new projects may be continuously be added to the project data in the remote network-based storage. It is understood that the capabilities of the augmented reality device, although purchased, will improve as the project library continues to grow and as methods for remotely analyzing environments, as well as identifying and measuring items, are improved on a remote computing environment.

According to various embodiments of the present disclosure, an augmented reality system is described that assists an operator (e.g., a wearer or viewer of augment reality eyeglasses) with various construction, manufacturing, or modification projects or tasks. Additionally, the augmented reality system is described to assist an operator (e.g., a wearer or viewer of augment reality eyeglasses) with various home improvement tasks, such as hanging artwork, picture frames, wall paper, wall decals, or similar items. Initially, the augmented reality system may assist with visualizing how a completed project may appear in an environment. For example, the augmented reality system may virtually impose a wall, a fixture, an appliance, an item of furniture, or other item in a display of an augmented reality device such that the item appears naturally in the setting and allows an operator to visualize a completed project. To this end, two-dimensional or three-dimensional modifications to an environment may be performed when an operator is performing an augmented reality session with his or her augmented reality device. The augmented reality system may generate various measurements of a setting or environment to assist in performance of a task or to assist with imposing the two-dimensional or three-dimensional modification to the environment. For example, the augmented reality system may use a detected object having a known size appearing in a video feed or other known augmented reality measuring processes, such as triangular mesh detection (as discussed below) to dynamically measure components in the environment, thereby assisting with visualization and completion of a task as will be described.

Prior to starting a project, the operator may customize various aspects of the project, such as adjusting a size or shape of a wall to be constructed. Alternatively, the operator may iterate through different items shown in an environment, such as browsing through different brands or types of or refrigerators, light fixtures, or other fixtures or appliances. Thereafter, once an item to construct, manufacture, modify, or other project is specified by the operator, the augmented reality system may generate a series of tasks for the operator to perform to complete the project. For instance, after the operator has specified a location, size, and shape of a wall to construct, the augmented reality system may identify tasks for the operator to perform, such as cutting lumber, positioning and installing lumber in appropriate locations, installing insulation, running electrical wiring, installing drywall, mudding the drywall, laying tile or installing other types of flooring, and painting.

To this end, the augmented reality system may assist with each project by identifying tasks to complete the project while sequentially displaying the task to perform. Moreover, the augmented reality system may assist the operator in performing each task. In the example above pertaining to cutting lumber (e.g., 2×4s) to build a frame for a wall, the augmented reality system may display, for example, a task of cutting a 2×4 to a length of four feet. The augmented reality system may employ object recognition to recognize a 2×4, measure a length (or other dimension) of the 2×4 for the operator, and virtually impose a mark, score, or cut line on the 2×4 such that a holographic line is shown in the augmented reality device. The operator may be instructed to score or create a mark along the cut line, or the operator may be instructed how to operate a saw and perform a cut along the cut line ensuring a correct cut. Guidance during the cut may also be provided, for example, by instructing the operator to move the saw to down, up, left, right, adjust an angle of approach, etc. Additionally, the operator may be warned if his or her hand is getting too close to a saw blade. Thereafter, the augmented reality system may analyze a completed cut to determine whether the cut was satisfactorily performed. If not, the augmented reality system may assist with performing a remedial task (e.g., sanding) or redoing the task. When satisfactorily completed, the next task in the series of tasks may be shown to the operator until a project has been completed.

While various examples provided throughout the present disclosure and various figures described herewith may pertain to the construction of a wall, this is merely but one example project described with respect to the augmented reality system. In further embodiments, the augmented reality system may be used to replace or install a fixture or appliance, install a light fixture, remodel a room, lay tile, pour concrete, level a floor, or other projects as may be appreciated.

For example, another project may include installation of plumbing in a sink cabinet. The tasks identified for the project may include, for example, building or transferring plumbing from an old unit, cutting out the back of a cabinet, connecting the plumbing to a fixture, and other tasks. When performed manually, the project is labor intensive as many measurements must be performed, for example, on the back of the cabinet and inside the cabinet to confirm the location for the plumbing. In various embodiments described herein, a remote computing environment confirms the location of plumbing by using dimensions of a known item or location, such as a wall or a cabinet, and extrapolating those dimensions to programmatically determine dimensions of the cabinet. An augmented reality session may include overlaying graphics where the cabinet will be positioned, accounting for counter top, over hang, etc. The location of the drain line and water lines may be shown, for example to assist the operator in determining the correct size and location of a hole to be made in the back of the cabinet.

In another example, a project may include moving large items of furniture, such as a piano, a bed, a desk, a table, or other residential, commercial, or industrial equipment. The tasks associated with the project may include, for example, scanning an item of furniture with an augmented reality device such that a remote computing environment can determine the dimensions associated with the furniture to be relocated. The dimensions of the furniture may be overlaid or otherwise imposed in an augmented reality environment, for example, in view of the person walking the path to the final destination. In some embodiments, the overlaid image may change colors or a sound may be emitted for areas not large enough to receive the furniture. Moreover, the remote computing environment may calculate areas and angles that will have interference and proposing rotating the piece to determine the best angle for the piece to be held when approaching a tight opening.

In the following discussion, a general description of an augmented reality system for task completion and its components is provided, followed by a discussion of the operation of the same.

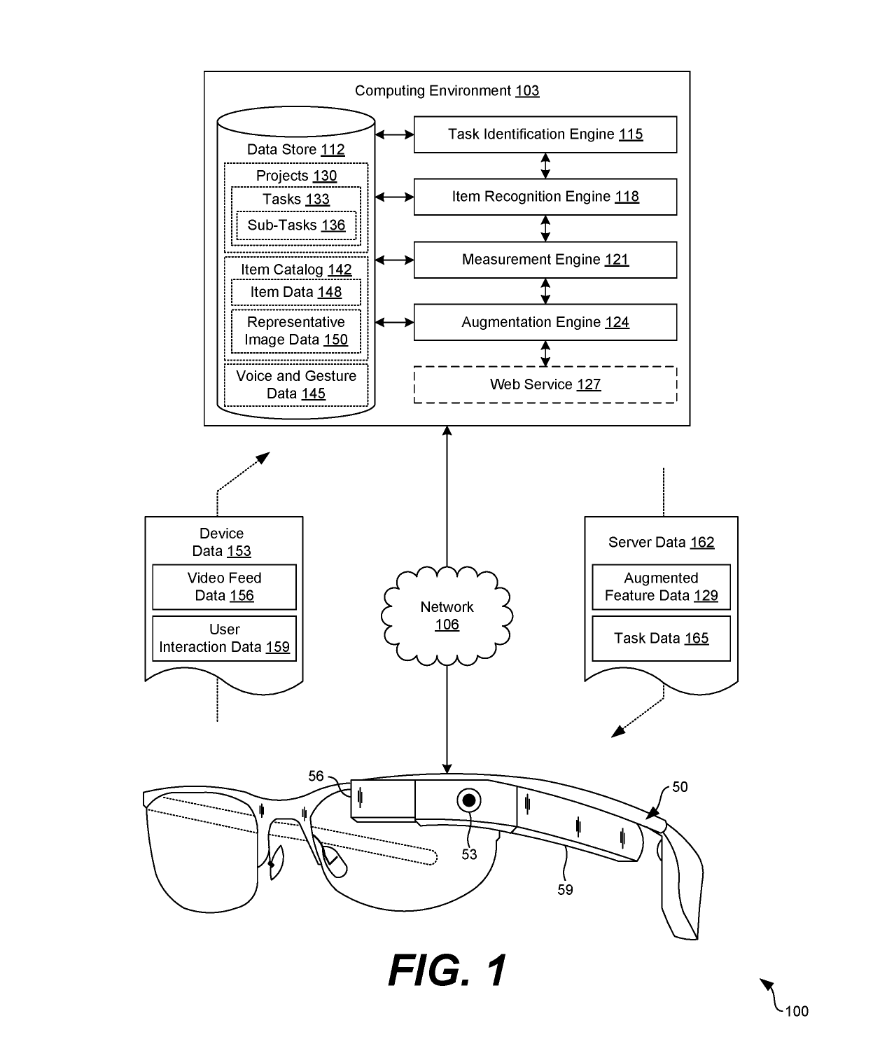

With reference to FIG. 1, an augmented reality device 50 is shown in a networked environment 100. As may be appreciated, the augmented reality device 50 may include “smart glasses,” which may be worn by an operator in a similar fashion to traditional eyeglasses. However, unlike traditional eyeglasses, the “smart glasses” include a camera 53, a projector (not shown), and a semi-transparent prism 56 may be used to project computer-generated images onto the retina of an operator. Additionally, the “smart glasses” may include a housing 59 for a network interface, a microphone, and processing circuitry, where the processing circuitry may include at least one hardware processor, graphics processing unit (GPU), or other processing circuitry. In other embodiments, the augmented reality device 50 may include a smartphone, a tablet, or similar computing device which, in turn, may include a display, a camera, a network interface, a microphone, and processing circuitry. The lenses of the augmented reality device 50 may include safety lenses or the augmented reality device 50 may be formed as safety goggles or a facemask according to various embodiments.

The augmented reality device 50 may include one or more application programming interfaces (APIs) that provide spatial mapping data that may be analyzed by processing circuitry of the augmented reality device 50 or sent to a computing environment 103 for remote analysis. The spatial mapping data may provide a detailed representation of real-world surfaces in an environment perceived by the augmented reality device 50 as well as its operator or user. The spatial mapping data, through one or more APIs, permits developers to customize a convincing mixed- and augmented-reality experience. By merging real world with virtual or augmented objects, an application executed by the augmented reality device 50 can make virtual objects, also referred to as holograms, appear realistic. It is also beneficial for an application executing on the augmented reality device 50 to have features that align with user expectations by providing familiar real-world behaviors and interactions.

The networked environment 100 includes the augmented reality device 50 and a computing environment 103, which are in data communication with each other over the network 106. Together, the augmented reality device 50 and the computing environment 103 may be described as forming an augmented reality system. The network 106 includes, for example, the Internet, intranets, extranets, wide area networks (WANs), local area networks (LANs), wired networks, wireless networks, or other suitable networks, etc., or any combination of two or more such networks. For example, such networks may comprise satellite networks, cable networks, Ethernet networks, and other types of networks.

The computing environment 103 may comprise, for example, a server computer or any other system providing computing capability. Alternatively, the computing environment 103 may employ a plurality of computing devices that may be arranged, for example, in one or more server banks, computer banks, or other arrangements. Such computing devices may be located in a single installation or may be distributed among many different geographical locations. For example, the computing environment 103 may include a plurality of computing devices that together may comprise a hosted computing resource, a grid computing resource, a cloud computing resource and/or any other distributed computing arrangement. In some cases, the computing environment 103 may correspond to an elastic or cloud-based computing resource where the allotted capacity of processing, network, storage, or other computing-related resources may vary over time. While described as a remote computing environment and as a separate component from an augmented reality device 50, in additional embodiments, some or all of the functions of the computing environment 103 may be performed in a computing device built into the augmented reality device 50.

Various applications or other functionality may be executed in the computing environment 103 according to various embodiments. Also, various data is stored in a data store 112 that is accessible to the computing environment 103. The data store 112 may be representative of a plurality of data stores 112 as can be appreciated. The data stored in the data store 112, for example, is associated with the operation of the various applications and/or functional entities described below.

The components executed on the computing environment 103, for example, include a task identification engine 115, an item recognition engine 118, a measurement engine 121, an augmentation engine 124, a web service 127, and other applications, services, processes, systems, engines, or functionality not discussed in detail herein.

The task identification engine 115 is executed to, for a given project 130, identify tasks 133 or sub-tasks 136 to be performed to complete the given project 130. For instance, for a project 130 that includes the operator adding a new wall or modifying an existing wall, the task identification engine 115 may identify tasks 133 for the operator to perform, such as cutting lumber, positioning and installing lumber in appropriate locations, installing insulation, running electrical wiring, installing drywall, mudding the drywall, and painting.

The item recognition engine 118 is executed to identify objects from an environment based on, for example, a visual analysis of the environment. To this end, the augmented reality device 50 may provide images or data associated with images captured by the camera 53 to the computing environment 103, where the item recognition engine 118 is configured to apply known object detection algorithms to identify objects. In some embodiments, the object detection algorithms include edge detection (e.g., Canny edge detection), divide-and-conquer search, greyscale matching, histograms of receptive field responses, or any combination thereof.

The measurement engine 121 is executed to perform measurements of objects detected by the item recognition engine 118 or other form of measuring as can be appreciated. In some embodiments, an object detected by the item recognition engine 118 may be employed by the measurement engine 121 in determining a size of other objects in the environment. Additionally, the measurement engine 121 may account for changes in perspective for example, by applying the equation of perspective projection or any form of triangulation.

The augmentation engine 124 is executed to generate augmented features to include in an augmented environment, which is then sent to the augmented reality device 50 as augmented feature data 129. Upon receipt of the augmented feature data 129, the augmented reality device 50 uses the data to impose or overlay graphics, images, text, or other data in the environment.

The web service 127 is executed to provide a medium for communication between the computing environment 103 and the augmented reality device 50 over the network 106 or other device. The web service 127 may comprise a web-based application programming interface (API) embodied in software that facilitates programmatic service calls or API calls made by a client application (e.g., an application executing in the augmented reality device 50) to communicate with the components of the computing environment 103, such as the task identification engine 115, the item recognition engine 118, the measurement engine 121, the augmentation engine 124, or other services or applications not described herein. According to various embodiments, the web-based API may further comprise a representational state transfer (REST) API, a simple object access protocol (SOAP) API, a hypertext transfer protocol (HTTP) API, or another suitable API.

The data stored in the data store 112 includes, for example, projects 130, an item catalog 142, voice and gesture data 145 and potentially other data. The item catalog 142 includes various information associated with items that may be used to either identify items in an environment or virtual impose (or overlay) items in the environment. Items may correspond to products, goods, and so on used in construction, manufacturing, home remodeling, or other related industries. To this end, the items may include appliances, fixtures, materials, paint colors, etc. Item data 148 may include information regarding each of the items, such as a name, description, price, weight, material, and so on. Item data 148 may further include installation instructions, product constraints (e.g., operating temperatures), original equipment manufacturer (OEM) data, as well as building codes associated with the items, if applicable. OEM data may include restraints for various products (e.g., temperature ranges, materials that require use with product) as well as OEM recommendations, such as recommended uses or installation locations. The item catalog 142 may further include representative image data 150 which may be used by the augmentation engine 124 in imposing a two-dimensional or three-dimensional view of an item in an augmented environment.

The voice and gesture data 145 may include data used to map a corresponding voice command or hand gesture to an action performed in association with an environment. For instance, various voice commands or hand gestures may be used to start or refine a project 130. In one example, a finger or a hand of an operator may be followed to identify a start location and an end location for a particular area to be modified. In another example, a particular marker or object having a predetermined characteristic may be used. In another example, the eyes of the operator may be tracked (e.g., using an additional camera) to identify locations being perceived by the operator as well as to recognize particular eye movements to select projects 133, change layouts, etc. Additionally, the operator may be able to point or tap on holographic user interface elements to select projects 133, change layouts, assign dimensions to projects 130, etc.

The augmented reality device 50 is representative of a plurality of augmented reality devices 50 that may be coupled to the network 106. The augmented reality device 50 may include, for example, a processor-based system built into the device such as a computer system. Such a computer system may be embodied in the form of a laptop computer, personal digital assistants, cellular telephones, smartphones, music players, tablet computer systems, smart glasses, virtual reality head-mounted devices, or other devices with like capability.

In some embodiments, the augmented reality device 50 may include a display. The display may include, for example, a liquid crystal display (LCD) display, gas plasma-based flat panel display, organic light emitting diode (OLED) display, electrophoretic ink (E-ink) display, LCD projector, or other types of display device. In various embodiments, the augmented reality device 50 includes various I/O devices such as a camera 53 (e.g., a front-facing camera or a rear-facing camera), a microphone, a speaker, a keyboard, and/or other suitable devices.

The augmented reality device 50 may be configured to execute various applications such as a client application. The client application may be executed in the augmented reality device 50, for example, to access network content served up by the computing environment 103 or other servers, thereby rendering a user interface is a display or rendering augmentation features such that they appear naturally in the environment. In various embodiments, the client application is executed in the augmented reality device 50 to capture an environment using the camera 53, for example, while performing an augmented reality session where the operator is positioned in or is navigating the environment. In various embodiments, a “pass-through device” allows the real world to be perceived through the device's clear lenses, and images (holograms) are projected in front of the user, up to several meters away from the user, or on the retina of the user. In various embodiments, the augmented reality device 50 includes Spectacles by Snap, Inc., Vuzix® Blade 3000, Vuzix® M300, ODG® R7 AR/R8, ODG® R7 AR/R9, Vue® Smartglasses, Level, Google® Glass, Epson® Moverio BT-300, Sony® SmartEyeGlass, Jins® Meme, Microsoft® HoloLens, or other similar device.

Next, a general description of the operation of the various components of the networked environment 100 is provided. To begin, as may be appreciated, an operator may activate an augmented reality device 50, for example, by wearing and powering on augmented reality eyeglasses. Alternatively, the operator may execute a client application on a smartphone, tablet, or similar device to start an augmented reality session. When executed, the client application may utilize the various input/output (I/O) devices of a client device (e.g., a smartphone or tablet) to obtain information about the environment. For example, the augmented reality device 50 may utilize its camera and microphone to generate a recording of the environment.

In some embodiments, device data 153 may be generated by the augmented reality device 50 to include spatial surface data, which may triangle mesh data. For instance, to obtain data regarding a particular area of an environment (or the environment as a whole), the computing environment 103 or an application executing on the augmented reality device 50 may provide an operating system of the augmented reality device (or other application) with one or more bounding volumes to define the regions of space in which the application wishes to receive spatial mapping data or can use such data to triangulate a location of the augmented reality device 50 in an environment.

For each of the bounding volumes, spatial mapping data may include a set of spatial surfaces. Spatial surfaces may be static or in a fixed location with respect to a real world environment, or they may be dynamic with respect to the augmented reality device meaning that they move along with the augmented reality device 50 as it moves through the environment. Spatial surface data may include data describing real-world surfaces in a small volume of space, represented as a triangle mesh attached to a world-locked spatial coordinate system. As the augmented reality device 50 obtains new information about the environment, and as changes to the environment occur, spatial surfaces in the spatial surface data may appear, disappear and change, as may be appreciated. The Microsoft® HoloLens® includes a measurement API that allows measurements to be performed, where the API returns a distance or a measurement in meters (inch or other measures). The augmented reality device 50 may further include one or more physics simulation APIs that may assist with imposing virtual objects in the environment.

For embodiments in which the augmented reality device 50 includes smart glasses, the augmented reality session may include the augmented reality device 50 being worn by the operator, where the projector and the semi-transparent prism 56 are used to project computer-generated images (also referred to as “augmentation features” herein) onto the retina of an operator. For embodiments in which the augmented reality device 50 includes a smartphone, tablet, or similar computing device, the augmented reality session may include the augmented reality device 50 rendering a live video feed captured by the camera in real-time, where portions of the video feed are augmented by adding computer-generated images to the video feed shown in a display.

In one embodiment, to start a new project 130, an operator may make a suitable voice command. For example, an operator of the augmented reality device 50 may say aloud “Start new project,” and the augmented reality device 50 may generate a user interface or verbally interact with the operator to further refine the type of project 130. In another example, an operator of the augmented reality device 50 may say, with more particularity, “Start HVAC unit replacement project.” Audio samples, or data pertaining to the audio samples, may be transmitted by the augmented reality device 50 to the computing environment 103 as device data 153 for remote analysis. The device data 153 may include video feed data 156 as well as user interaction data 159. For instance, the computing environment 103 may analyze user interaction data 159, in this case audio data, to identify predefined voice commands stored as voice and gesture data 145.

In another embodiment, an operator of the augmented reality device 50 may make a recognizable gesture to start a new project 130. For instance, a hand swiping motion may be performed by the operator. Video feed data 156, or data associated therewith, may be captured by the camera of the augmented reality device 50 and sent to the computing environment 103 for remote analysis. The computing environment 103 may compare the gesture to predefined gestures stored in the voice and gesture data 145. In embodiments where the augmented reality device 50 includes a smartphone or a tablet, a suitable user interface may be shown in the display that allows the operator to refine his or her project 130 through interactions made with a touch screen display or other input device.

If a project 130 specified by the operator is recognized by the computing environment 103, parameters for the project 130 may be received from the operator or otherwise defined, for example, using default values. For instance, if the operator intends to construct a wall during a bathroom remodel, a width, height, length, and shape of the wall may be specified through suitable voice commands, gesture recognition, or user interface interaction.

Moreover, the computing environment 103 may be configured to perform various measurements, such as measuring a width, length, or height of an object or measuring an area of a space in the environment, which may be accomplished using triangle mesh data or similar data. In some embodiments, the measurements may be used as a parameter of the project 130. For instance, if the operator intends to build a towel closet for a bathroom, a measurement from a first wall of the bathroom to a second wall may be determined. In another example, if the operator intends to install new flooring in a room, a square footage of the floor may be determined. Other dimensions may be determined, as may be appreciated.

The computing environment 103 may generate and transmit server data 162 to the augmented reality device 50, where the server data 162 may include augmented feature data 129 as well as task data 165. The augmented feature data 129 may instruct the augmented reality device 50 to perform a particular augmentation to the environment, such as imposing a three-dimensional model in the environment to visualize a completed project 130, displaying text or a how-to video, or other appropriate augmentation. For instance, the augmented reality system may propose various layout options for remodeling a room which can be cycled through by the operator or selected and customized. In one embodiment, an operator may be presented with a bedroom remodel having a placement of a closet in one area of the room, a particular color of paint on the walls, a certain ceiling fan, etc. If the operator likes the layout, he or she may customize various aspects, such as changing the ceiling fan or adjusting the color of the paint on the walls. Alternatively, the operator may make a suitable gesture or voice command to receive another suggested layout of the room for the remodeling project 130.

Additionally, the augmentation to the environment may include, for example, displaying information pertaining to a part or item in relation to the part or item, imposing a cut line on material to be cut, displaying a video in the environment that shows an example completion of a task 133, imposing or overlaying a virtual measurement on an item, imposing a level gauge or a square tool in an environment or on a material surface, overlaying a virtual grid or level line in an environment, or some other form of augmentation. Thus, the augmented reality device 50 can be used as a replacement for a traditional level, square, contour gauge or other measuring device.

In additional examples, for projects 130 in which an operator intends to replace a refrigerator or other appliance, an image of a new model of a washer or dryer may be shown in the area where a washer or dryer stands or once stood. In another example, a remodeled room may be shown having different paint or wallpaper, different flooring, and different appliances or fixtures. To this end, the augmented reality system may generate a visualization of the completed form of the project 130 using parameters of the project 130 and measurements performed by the computing environment 103. In various embodiments, the augmented reality system may generate suggested layouts or replacement items for display based on various suppliers of materials or products.

In some embodiments, augmenting the environment in the augmented reality session may include generating a two-dimensional or three-dimensional visualization using at least one representative image for the project 130 stored as representative image data 150. Additionally, the at least one representative image may be modified such that the visualization of the project 130 conforms to the environment. While the disclosure described herein uses representative images, it is understood that in other embodiments, computer-generated models may be utilized.

Based on a project 130 and the specified parameters, the computing environment 103 may identify tasks 133 for the operator to perform to complete the project 130. For example, if the operator intends to construct a closet, the tasks 133 may include cutting appropriate sized lumber, arranging the cut pieces of lumber to build a frame, securing the frame to the structure, running electrical wiring, hanging drywall, etc. Additionally, a sequence for the tasks 133 may be determined to optimize labor, materials, or to coalesce similar operations. For example, if a project 130 includes constructing a wall, all tasks 133 requiring cut to 2×4s or other lumber may be coalesced to reduce required labor for overall completion of the project 130. For example, the operator may only need to use his or her saw for a subset of the tasks 133, thus, would only have to access his saw for a single and sequential group of tasks 133. Additionally, the cuts may be determined, for example, based on an analysis of different standard lengths of 2×4s such that the cuts are determined to optimize use of available materials, minimize scrap, etc. This may reduce the amount of materials, thereby benefiting the environment and providing sustainable construction and remodeling solutions.

When received by the augmented reality device 50, the augmented reality device 50 may sequentially impose or overlay data associated with a task 133 in the environment. For example, if through a voice command, gesture, or user interface input the operator indicates that he or she desires to start performance of the project 130, a first task 133 may be overlaid in a position of the environment shown during the augmented reality session. As may be appreciated, a completion of a one task 133 may cause a transition to a subsequent task 133. Also, a given task 133 may include various sub-tasks 136. For example, a task 133 of coupling a first piece of polyvinyl chloride (PVC) conduit to another piece of conduit may include the sub-tasks 136 of cutting the conduit as well as applying glue or a fitting. It is understand that the augmented reality system may walk the operator through each task 133 and sub-task 136 sequentially until completion of the project 130.

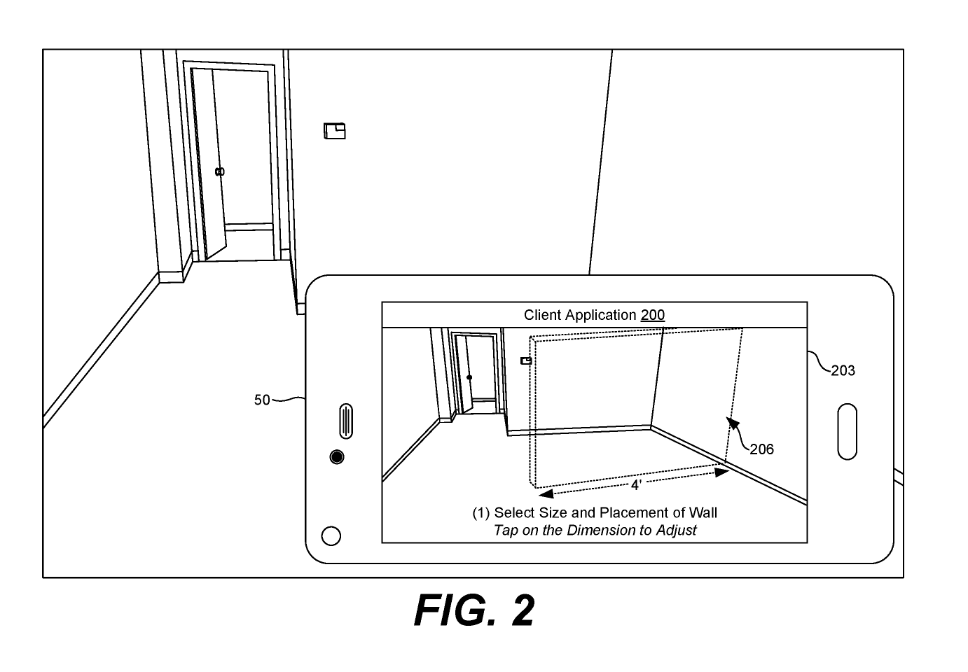

Referring next to FIG. 2, an augmented reality device 50 is shown as a client device (e.g., a smartphone or tablet) where an augmented environment is shown in a display 203 when a client application 200 is executed. While the embodiment of FIG. 2 utilizes a smartphone having a display 203, it is understood that augmented features may be shown using the components of the smart glasses, are discussed above with respect to FIG. 1.

The augmented reality device 50 may comprise various I/O devices, such as a front-facing camera, a rear-facing camera, a microphone, a speaker, a network interface, as well as other components. To this end, the augmented reality device 50 may be capable of capturing audio and video from an environment and, in real-time, cause playback of the audio or video on the augmented reality device 50. For example, the video being recorded by the front-facing camera (or the rear-facing camera) may be rendered in the display 203 of the augmented reality device 50 while any audio being recording by a microphone may be played through a speaker of the augmented reality device 50.

As shown in FIG. 2, the environment (e.g., the room) is reproduced in the display 203 of the augmented reality device 50; however, an augmented feature 206 (e.g., an outline of a wall) is shown. In this example, it is assumed that the operator intends to construct a wall, where the client application 200 assists the operator was selecting the size and placement of the wall. The augmented feature 206 is a dashed line that defines an outline of a wall to allow the user to customize the parameters of the wall (e.g., the dimensions or placement of the wall). While the operator may utilize a touchscreen in the example of FIG. 2 to adjust the size and position of the wall in the environment, it is understood that suitable gestures or voice commands can perform equivalent functions. In some scenarios, it may be beneficial for the augmented feature 206 to be semi-transparent as the operator may desire to see items being the augmented feature 206.

In some embodiments, the computing environment 103 may perform measurements of items detected during an augmented reality session. In one embodiment, a height of the wall may be measured based on a reference object. For example, a thermostat on the wall may be recognized and used as a reference for determining the height of the wall using known methods. The measurements for an existing may be used as parameters of the project 130, or may be used in generating an initial view of the wall permitting further customization or modification. It is understood that the text labels, instructions, buttons, and other user interface components shown in the augmented reality sessions described herein are also augmented (e.g., they do not actually appear in the actual environment, but are included in the augmented environment).

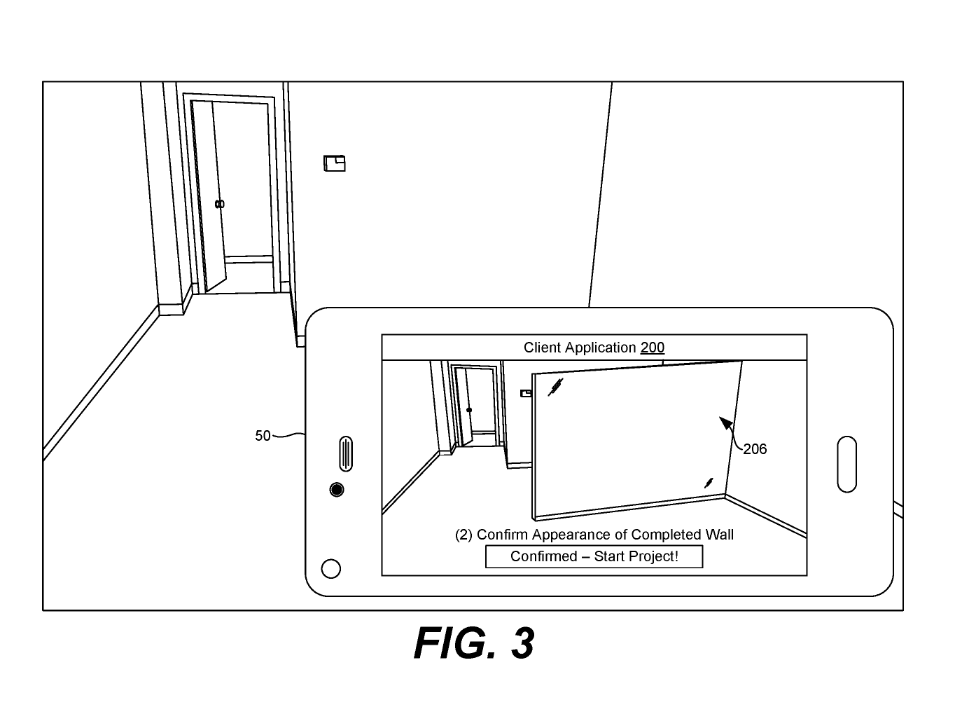

Turning now to FIG. 3, the augmented reality device 50 may augment the environment using the project parameters after customization of a project 130. For instance, an augmented feature 206, a three-dimensional wall in this case, may be imposed or overlaid in the environment such that the operator is able to visualize a completed project 130. It is understood that the operator may be able to further refine the project parameters based on the visualization, or the operator may wish to begin being presented with tasks 133 to complete the project 130. In additional embodiments, the augmentation to the environment may include, for example, displaying information pertaining to a part or item in relation to the part or item, imposing a cut line on material to be cut, displaying a video (e.g., a YouTube® video) in the environment that shows an example completion of a task 133, imposing a virtual measurement on an item, or other augmentation.

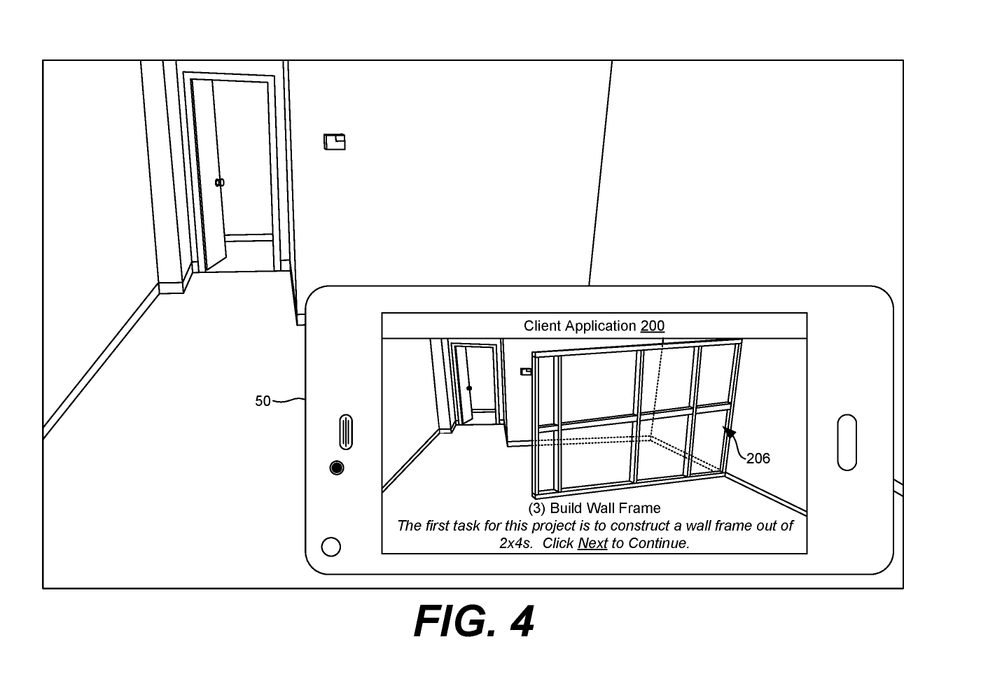

Moving on to FIG. 4, another augmented environment is shown according to various embodiments. In the non-limiting example of FIG. 4, a visualization of a completed task 133 is shown, as opposed to the completed project itself. For instance, the task 133 of constructing a frame out of lumber is shown instead of a completed wall. The augmented feature 206 may assist the user in visualizing completion of the task 133 (or sub-task 136). As may be appreciated, when the operator starts with a task, the client application 200 (or other interface) may augment the environment to assist the operator in performing the task 133. For instance, after the operator has specified a location, size, and shape of a wall to construct, the augmented reality system may identify tasks 133 for the operator to perform, such as cutting lumber, positioning and installing lumber in appropriate locations, installing insulation, running electrical wiring, installing drywall, mudding the drywall, and painting.

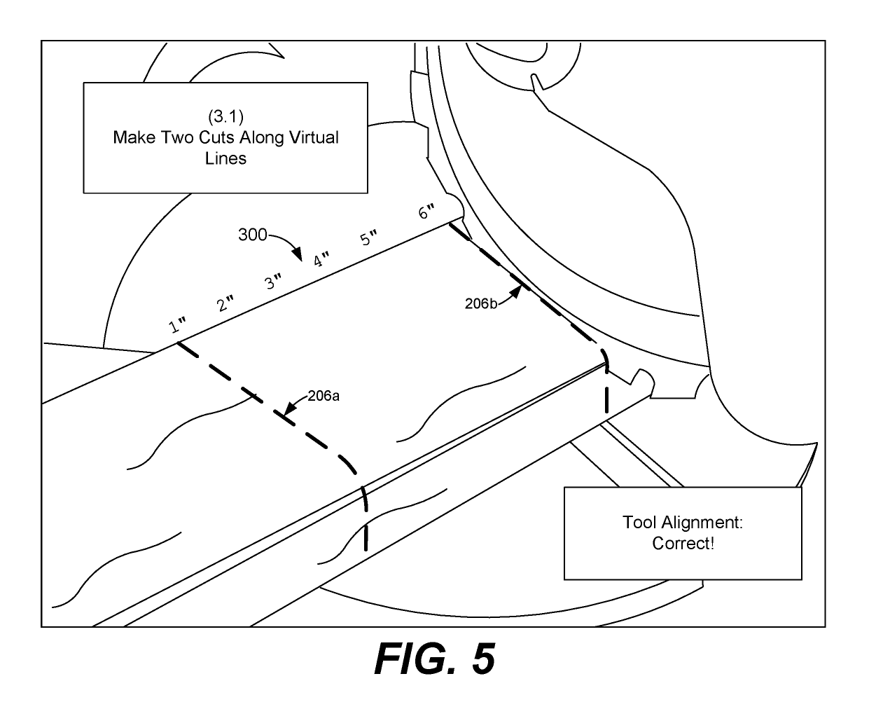

For instance, as shown in FIG. 5, an augmented environment is shown as if the user is wearing smart glasses to assist the operator is cutting lumber to build the frame. The task 133 of building the frame may subdivided into sub-tasks 136, as may appreciated. In the non-limiting example of FIG. 5, a first augmented feature 206a includes a line for a first cut to be made and a second augmented feature 206b includes a line for a second cut to be made. It is understood that the augmented features 206, such as cut lines, may be imposed based on a measurement performed programmatically by the computing environment 103. For instance, a measuring device 300 having numbers listed on a saw (or other points of reference) may be identified using optical character recognition (OCR) and a width between cut lines may be determined. In additional embodiments, the item to be cut can be used as a reference object itself.

If an item, such as a saw, is improperly located (e.g., in the wrong direction, position off level or out of square), a part to cut may be highlighted to indicate the proper location or position. In some embodiments, the cut lines may be shown as the cut is performed or, in other embodiments, the cut lines may be shown to allow an operator to physically mark or scribe the cut lines using a pen or pencil. In further embodiments, measuring dimensions may be imposed as virtual objects in the augmented reality session. The cut lines, dimensions, or other augmented features 206 may be shown to optimize use of materials.

In various embodiments, the augmented reality system may facilitate with tapering or leveling a floor or other surface. For instance, when an operator is installing gravel for a driveway or pavers for a walk path, the augmented reality system may identify non-level portions of an environment and provide suitable tasks 133 for the operator to perform to install the gravel or pavers such that the driveway or the walk path is level. Similarly, the augmented reality system may include tasks 133 for tapering tile when the operator is laying tile on a floor that may be uneven. The augmented reality system may include tasks 133 to taper the newly installed surface into an existing surface (e.g., blending new flooring to match the same finished surface of old flooring).

In one example, the operator may identify a starting location where he or she desires to lay gravel and an end location, and the operator may be instructed to walk a perimeter of the area where the gravel is to be laid so that the augmented reality system can determine an area of the installation location (e.g., in cubic feet) and determine an amount of gravel required for installation. The augmented reality system may allow the user to mark the height of gravel and taper out to a certain distance while showing an overlay of the coverage.

Moreover, the augmented reality session may include presenting the operator with instructions to complete the task 133, such as “Make two cuts along the virtual lines.” The augmented reality system may further determine whether the operator has aligned the tool to complete the task 133 properly, or otherwise instruct the operator corrections that should be made for the task 133 to be completed. In further embodiments, a virtual level, virtual ruler or measurer, or a virtual square may be imposed or overlaid in the augmented environment to assist with performing square cuts, leveling items, or other tasks 133 that may require a level, a square, or a measurer.

In further embodiments, a first operator of a first augmented reality device 50 may be able to communicate with a second operator of a second different augmented reality device 50. In some embodiments, the first augmented reality device 50 communicates to the second augmented reality device 50 directly using Bluetooth® or other appropriate communication medium. In other embodiments, the first augmented reality device 50 communicates with the second augmented reality device 50 through the network 109 and through the computing environment 103.

To this end, some embodiments may include, for example, a first operator communicating information pertaining to a task 133 or a project 130 to the second operator. For instance, the first operator may select a layout and wireless communicate cut information to the second operator, who may be tasked with operating a saw to make cuts of raw material, while a third operator may be instructed to remove carpet for installation of hardwood flooring.

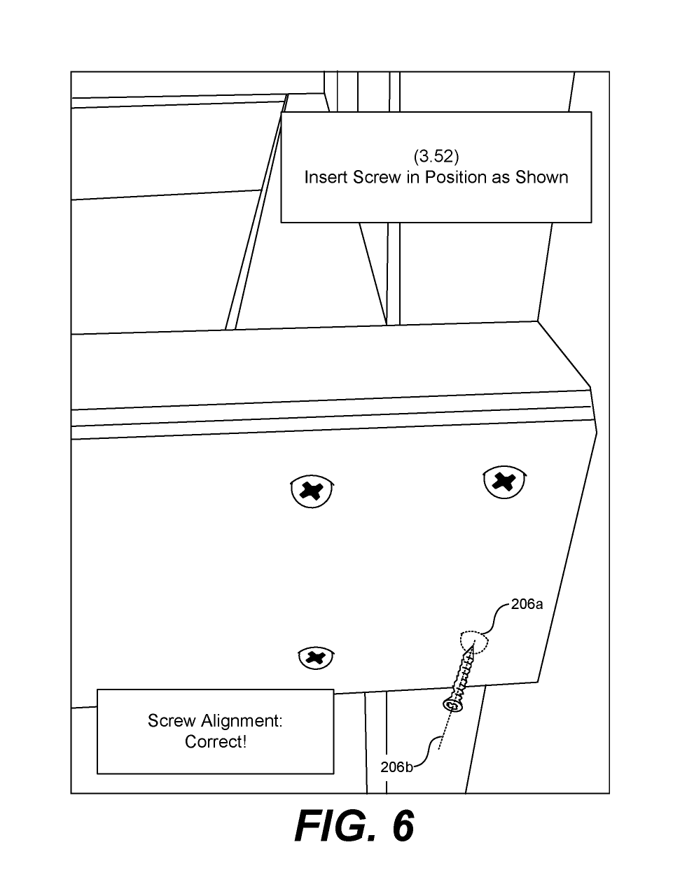

Referring next to FIG. 6, another augmented environment is shown as if the user is wearing smart glasses to assist the operator in connecting cut lumber to build the frame for the wall. In the non-limiting example of FIG. 6, a first augmented feature 206a includes a guidance line for an operator to assume to drill in a screw at a correct angle. A second augmented feature 206b includes a target location at which the screw should be inserted. The augmented features 206, such as the guidance line and the target location, may be imposed based on a measurement performed programmatically by the computing environment 103. For instance, the screw shown in FIG. 6 (as would be held by the operator), would have a known length which may be used as a point of reference in determining the target location or the guidance line. Also, in the example show in FIG. 6, the augmented reality session may include presenting the operator with instructions to complete the task 133, such as “Insert screw in position as shown.” The augmented reality system may further determine whether the operator has aligned the screw to complete the task 133 properly, or otherwise instruct the operator corrections that should be made for the task 133 to be completed.

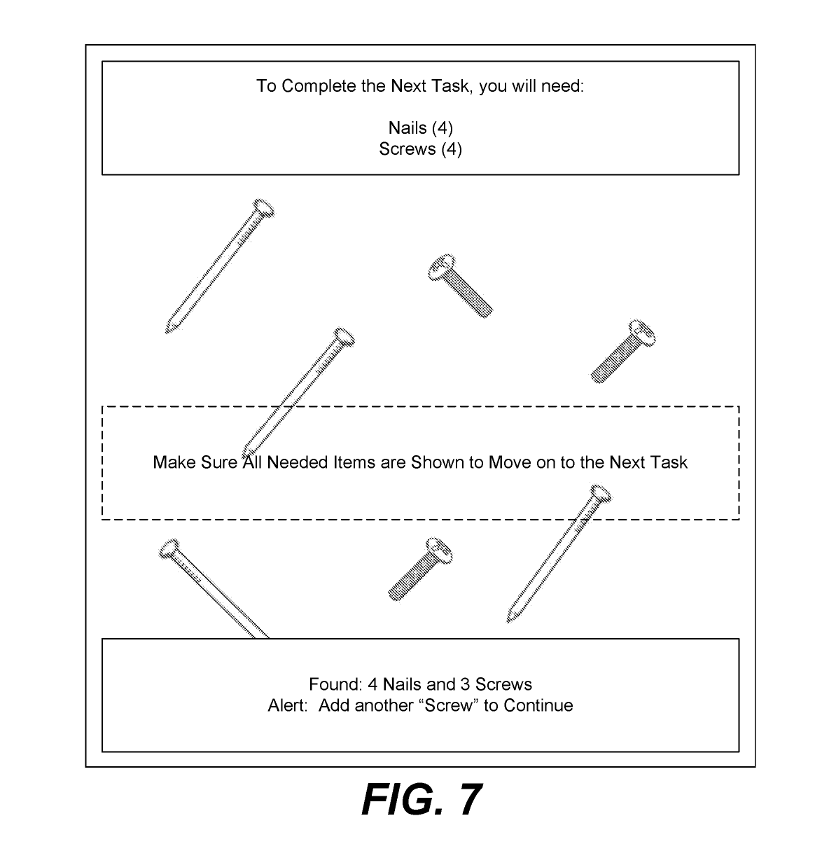

Turning now to FIG. 7, another augmented environment is shown as if the user is wearing smart glasses to assist the operator in verifying that he or she has all requisite materials to complete a task 133, sub-task 136, or project 130. In some embodiments, the augmented reality system may verify that each tool or item in a bill of materials (generation of which will be discussed below) has been gathered for the project 130. To this end, the augmented reality system may walk the operator through a process where each of the items is sequentially inspected by the augmented reality system where the items are visible by the camera. Object recognition may be employed to verify that each of the items in the bill of materials are available for use. For example, the augmented reality system may use pixel value thresholds to identify objects in an environment and compare the objects to data stored in the data store 112. For example, a region having a screw may be compared to data stored in the data store 112 to determine whether the object is a screw and, if so, determine a type, size, length, or other aspect of the screw to verify conformation with the bill of materials. In further embodiments, a receipt or a barcode (or other machine-readable identifier) corresponding to the items in the bill of materials may be analyzed using optical character recognition.

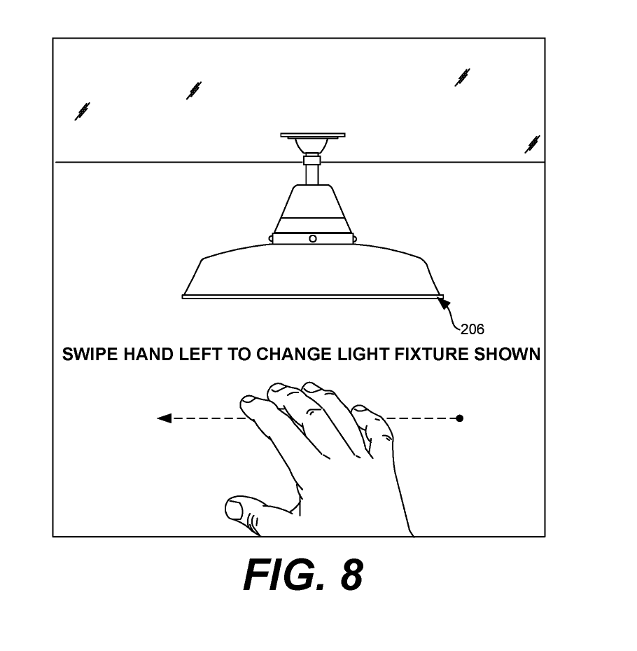

Moving on to FIG. 8, shown is a drawing of an augmented environment as if an operator were wearing the augmented reality device 50 as eyeglasses. For projects 130 in which an operator intends to replace a light fixture or other fixture or application, a two-dimensional or three-dimensional image of a light fixture may be shown as an augmented feature 206 in an area of the ceiling. Using a suitable voice command or, in this case, a gesture (e.g., by swiping a hand from the right to the left), another brand or type of light fixture may be replaced as the augmented feature 206. To this end, the augmented reality system may generate a visualization of the completed form of the project 130 using parameters of the project 130 and measurements performed by the computing environment 103. Additionally, the augmented reality system allows the user to quickly customize projects 130 by altering components used therein.

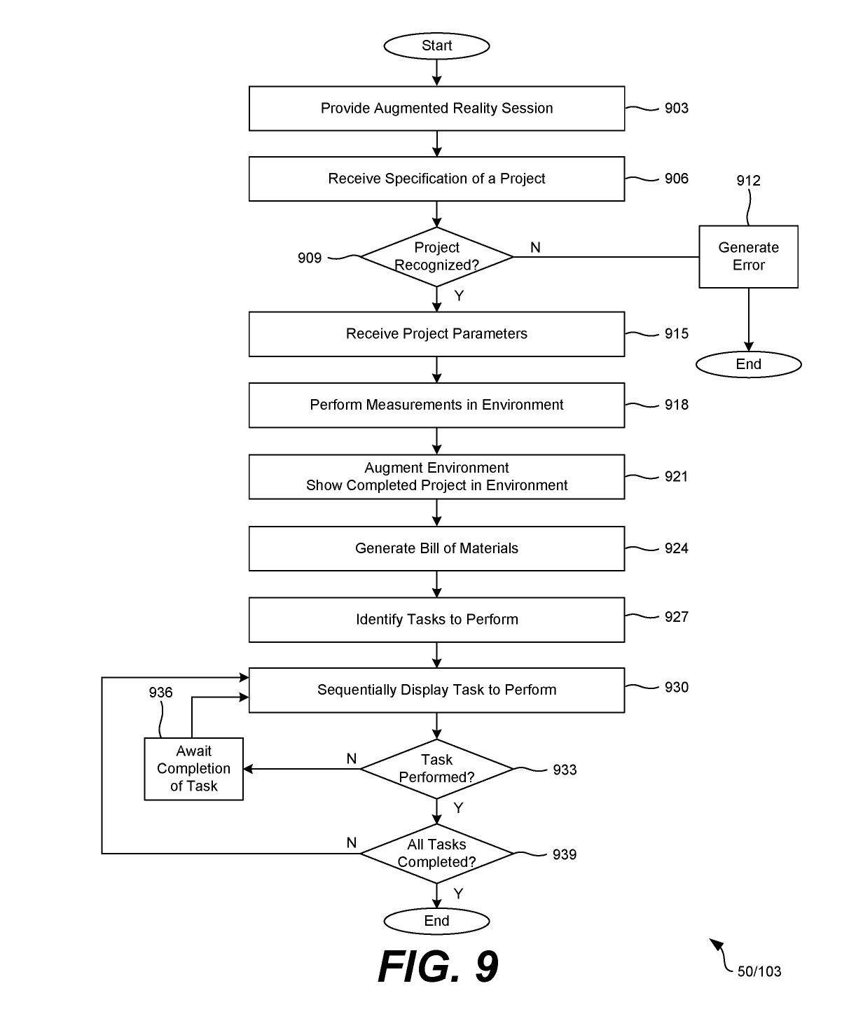

Referring next to FIG. 9, shown is a flowchart that provides one example of the operation an augmented reality system comprising an augmented reality device 50 and a computing environment 103 according to various embodiments. It is understood that the flowchart of FIG. 9 provides merely an example of the many different types of functional arrangements that may be employed to implement the operation of the portion of the augmented reality system as described herein. As an alternative, the flowchart of FIG. 9 may be viewed as depicting an example of elements of a method implemented in the augmented reality device 50 or the computing environment 103 according to one or more embodiments.

Beginning with 903, an augmented reality session may be provided to an operator (e.g., a wearer or viewer of smart glasses or a user of a smartphone). For embodiments in which the augmented reality device 50 includes smart glasses, the augmented reality session may include the augmented reality device 50 being worn by the operator where a small projector and may include a semi-transparent prism are used to project computer-generated images onto the retina of an operator. For embodiments in which the augmented reality device 50 includes a smartphone, tablet, or other similar computing device, the augmented reality session may include the augmented reality device 50 rendering a live video feed captured by the camera in real-time, where portions of the video feed are augmented by adding computer-generated images to the video feed shown in a display.

Next, in step 906, the augmented reality system may receive a specification of a project 130 to perform in an environment. To this end, in various embodiments, the specification of the project 130 may be received through various voice commands. In one example, an operator of the augmented reality device 50 may say aloud “Start new project” and the augmented reality device 50 may generate a user interface or verbally interact with the operator to further refine the type of project 130. In another example, an operator of the augmented reality device 50 may say, with more particularity, “Start new room remodeling project.”

In another example, the augmented reality device 50 may apply gesture recognition. For instance, a pinch motion may be performed by the operator, captured by the camera of the augmented reality device 50, and recognized by the computing environment 103 using voice and gesture data 145. The type of gesture may correspond to a particular type of project 130, or the gesture may simply bring up a user interface that allows the operator to further refine the project 130. The gesture recognition or voice commands may be captured or recorded by the camera of the augmented reality device 50 and recognized by the computing environment 103 using voice and gesture data 145, as may be appreciated. In embodiments where the augmented reality device 50 includes a smartphone or a tablet, a suitable user interface may be shown in the display that allows the operator to refine his or her project. To this end, items may be selected by swiping, tapping on, or otherwise interacting with the screen of the smart phone, tablet, or other device.

Thereafter, in step 909, the augmented reality system may determine whether the project specified by the operator is recognized. For example, the data store 112 may maintain a project catalog comprising predefined projects as well as tasks 133 to perform to complete those projects 130. Based on the specification of the project 130 in step 906, the data store 112 may be queried to determine whether the project is supported. For instance, if the operator specifies that he or she wishes to construct a wall or remodel a bathroom, the data store 112 may be queried to identify a database entry for “wall construction” or “bathroom remodel.” The search of the data store 112 may employ fuzzy matching, as may be appreciated.

If the project 130 is not recognized, the process may proceed to step 912, where the augmented reality system may generate an error and provide such error to the operator. For example, the operator may be instructed that the project 130 was not recognized or the operator may be asked to try another type of project 130. Thereafter, the process may proceed to completion.

Returning back to step 909, if the project 130 is recognized (e.g., the query to the data store 112 resulted in at least one match), the process may proceed to step 915, where parameters for the project 130 may be received from the operator or otherwise defined (e.g., based on default values). For instance, if the operator intends to build a wall, a width, height, length, and shape of the wall is specified through suitable voice commands, gesture recognition, or user interface interaction.

Additionally, although described separately in step 918, a measurement may be performed by the augmented reality system which may be used as a parameter of the project 130. For instance, if the operator intends to build a closet, a measurement from the floor to ceiling may be performed where a height of the closet is automatically determined based on the measurement. Additionally, a measurement from one wall to another may be performed to provide a suggested width for the closet, although such width may be customized as the operator sees fit.

In step 921, the augmented reality system may augment the environment in the augmented reality session by imposing a visualization of a completed form of the project 130 in the environment. For instance, for projects 130 in which an operator intends to replace a refrigerator or other appliance, an image of a new model of refrigerator may be shown in the area where the refrigerator stands or once stood. In another example, for projects 130 in which an operator intends to construct a wall, a three-dimensional rendering of the wall to be constructed in a specified area of the environment. In another example, a remodeled room may be shown having different paint or wallpaper, different flooring, and different appliances or fixtures. To this end, the augmented reality system may generate a visualization of the completed form of the project 130 using the at least one parameter and the at least one measurement. In some embodiments the dimensional information may come from an OEM manufacturer, for examples, from computer-aided drafting (CAD) files or from other product specifications.

In some embodiments, augmenting the environment in the augmented reality session may include generating the visualization using at least one representative image for the project 130. Additionally, the at least one representative image may be modified such that the visualization of the project 130 conforms to the environment, and generating augmented reality data that virtually imposes the at least one representative image in the environment during the augmented reality session. While the disclosure described herein uses representative images, it is understood that in other embodiments, three-dimensional, computer-generated models may be utilized.

In 924, based on the parameters for the project 130, a bill of materials may be generated and provided or shown to the operator. For instance, if the operator intends to replace a washer and dryer, the bill of materials may include a rubber or stainless steel braided hoses, a bucket, a gas flexy, a vent, gloves, or other materials. In some embodiments, the bill of materials may include a list of tools required to complete the project 130, such as slip-joint pliers, an open-ended wrench, a screwdriver, a sponge, an adjustable wrench, a rag, needlenose pliers, or other tools. Additionally, the augmented reality device 50 may provide the ability to order tools, materials, parts, or other items.

In some embodiments, the augmented reality system may verify that each tool or item in the bill of materials has been gathered for the project 130. To this end, the augmented reality system may walk the operator through a process where each of the items is sequentially inspected by the augmented reality system where the items are visible by the camera. Object recognition may be employed to verify that each of the items in the bill of materials are available for use. In other embodiments, a receipt or a barcode (or other machine-readable identifier) corresponding to the items in the bill of materials may be analyzed using optical character recognition.

Thereafter, in step 927, the augmented reality system may identify tasks 133 for the operator to perform to complete the project 130. For example, if the operator intends to construct a closet, the tasks 133 may include cutting appropriate sized lumber, arranging the cut pieces of lumber to build a frame, securing the frame to the structure, running electrical wiring, hanging drywall, etc. As may be appreciated, the tasks 133 stored in the data store 112 may correspond to a particular project 130 and the project 130 may be in conformance with the International Building Code (IBC) or a regional building code, as determined by a geographic location of the augmented reality device 50. The geographic location may be determine using network triangulation, a global positioning system (GPS) module, an internet protocol (IP) address, or other known methods for determining a geographic location of a network-enabled device. Additionally, the tasks 133 for a project 130 may be determined in accordance with OEM data, which may include, for example, installation constraints for a product.

Additionally, a sequence for the tasks 133 may be determined to optimize labor, materials, or to coalesce similar operations. For example, if a project 130 includes constructing a wall, all cuts of 2×4s or other lumber may be coalesced to save labor costs. Additionally, the cuts may be determined, for example, based on an analysis of different standard lengths of 2×4s such that the cuts are determined to optimize use of available materials.

In step 930, the augmented reality system may sequentially display each of the plurality of tasks in the display of the augmented reality device. For example, if the operator, through a voice command, gesture, or user interface input, indicates that he or she desires to start performance of the project 130, a first task 133 may be determined and shown in the augmented reality session. As may be appreciated, a completion of a one task 133 may cause a transition to a subsequent task 133. Also, a given task 133 may include various sub-tasks 136. For example, coupling a first piece of metal or plastic conduit to another piece of conduit may include cutting the pipe as well as applying glue or a fitting. It is understand that the augmented reality system may walk the operator through each task 133 and sub-task 136 sequentially.

Next, in step 933, the augmented reality system may determine whether the task 133 was performed (or performed satisfactorily). For example, a cut of a 2×4 may be analyzed to determine whether a straight cut was performed or that a length of the resulting piece of lumber is in conformance with the task 133. In another example, two coupled portions of conduit may be analyzed to determine whether the shape of the resultant conduit if correct as well as to verify a length or width of each portion of the conduit.

If the task 133 has not been performed (or not performed satisfactorily or within a threshold level of satisfaction), the process may proceed to step 936, where the augmented reality system may await completion of the task and, thereafter, the process may return to step 930. In further embodiments, if a task 133 is not performed satisfactorily, the augmented reality system may identify a remedial task 133 that, when performed, satisfies the relevant task 133. For instance, if a cut to a 2×4 was poorly made by an operator of the augmented reality device 50, the remedial task 133 may include sanding or remaking the cut. When satisfactorily completed, the next task 133 in the sequence of tasks 133 may be shown to the operator.

Referring again to step 933, if the task 133 was performed, the process may proceed to step 939. In step 939, a determination may be determined whether all tasks 133 (and sub-tasks 136) in a project 130 have been completed. In other words, a determination is made whether the project 130 is complete. If all tasks 133 have not been performed, the process may return to step 930 to continue sequentially displaying tasks 133. Alternatively, if all tasks 133 in a project 130 have been performed, the process may proceed to termination.

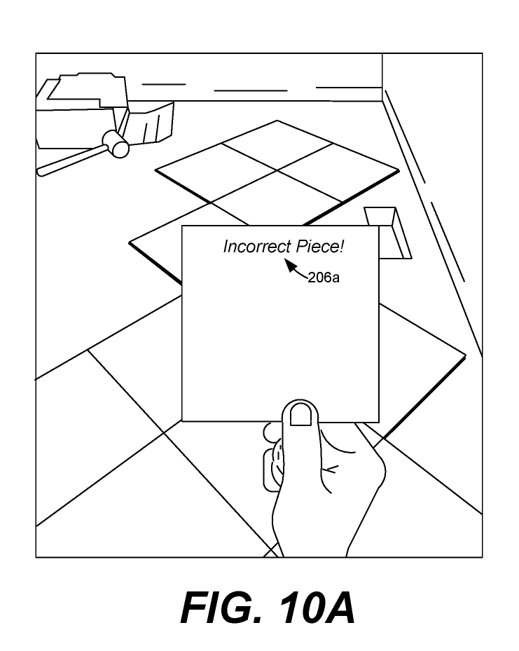

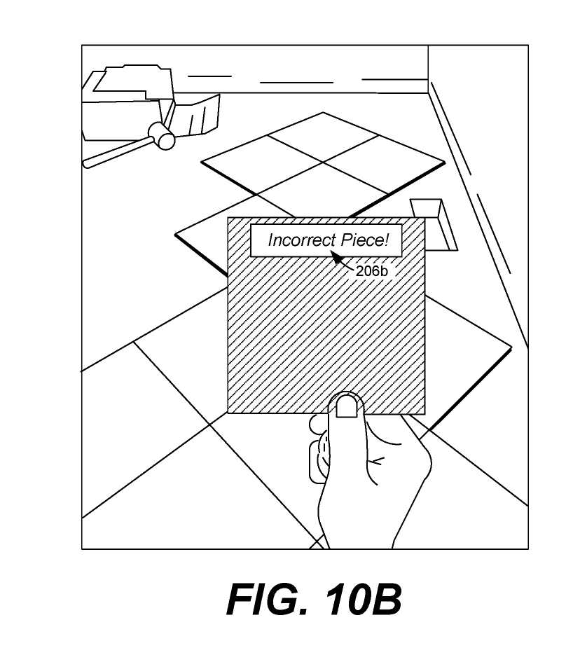

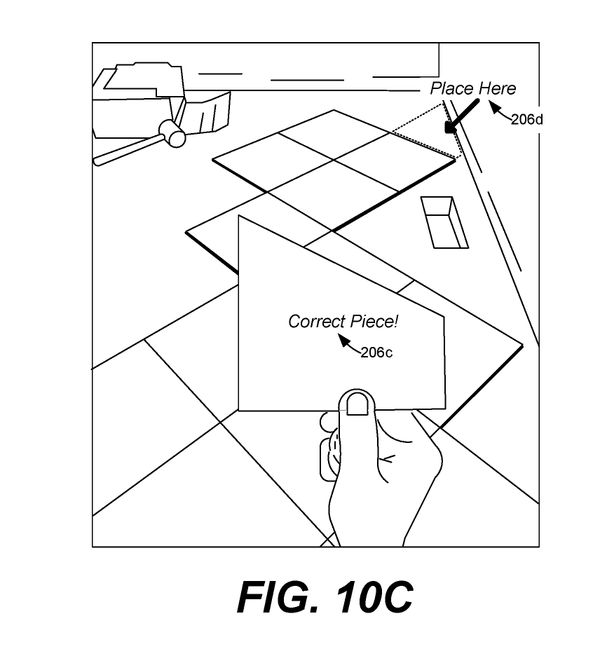

Turning now to FIGS. 10A-10C, an augmented reality session is shown where the augmented reality system is employed in an example project 130 that includes laying tile or other flooring material. In various embodiments, the augmented reality system may present tasks 133 that guides an operator for installing tile, laminate, hardwood, or other flooring. Prior to installing flooring, the augmented reality system may present various layouts of the tile to be installed, for example, in different patterns. The augmented reality system may allow the user to select the grout joint (gap between each tile). The layouts presented to the operator may also be suggested or shown such that installation would optimize use of available materials or minimize the amount of cuts needed by the operator. Additionally, the augmented reality system may facilitate with identifying all cuts needed to install the flooring based on the selected layout. As may be appreciated, optimizing use of resources minimizes leftover scrap and unused material, thereby the embodiments described herein are substantially beneficial for the environment while providing sustainable alternatives to traditional manufacturing, remodeling, and construction methods.

The augmented reality system may be further configured to identify a shape of an object being held by the operator, determine whether its appearance, texture, color or other characteristics matches that of the flooring being installed, and direct placement of the object if it is an appropriate shape or dimension of the flooring being installed. For instance, in FIGS. 10A and 10B, square pieces of tile is shown, where text is also shown as an augmented feature 206a and 206b indicating that the square piece of tile is an incorrect piece due to its size, color, or other characteristic. However, in FIG. 10C, a piece of tile is shown where text is also shown as an augmented feature 206c indicating that the piece of tile is the correct piece due to its size, color, or other characteristic. An augmented feature 206d is shown instructing the operator how to orient and where to place the identified item. As may be appreciated, the augmented reality system may facilitate with orienting the item for placement in a particular location in the environment showing an overlay (or highlighting area) when tile is square with room or level with walls

In another embodiment, an augmented reality system may assist with patching an existing floor such that a replacement piece of flooring blends into an existing flooring without creating an undesirable hazard. The augmented reality system can identify characteristics of the existing flooring and suggesting a replacement product to replace an area specified by the operator. Depending on the material, the augmented reality system may identify tasks 133 to perform to patch the floor, such as gluing and matching ceramic tiles. The augmented reality system can use dimensions from existing surfaces in a room and overlay square lines and may highlight areas that are out of square and help square or level up walls, window doors and other items, as can be appreciated.

In another embodiment, the augmented reality system may analyze internal components (or the lack thereof) of an object to virtualize the internal components at a later time. For example, the augmented reality system may analyze the components of a wall that has no drywall installed thereon. The identified components can be stored in the data store 112, for example, as a virtual blueprint. The augmented reality system may thus determine the location of studs or other lumber, as well the presence and location of electrical wiring, conduit, insulation, or other materials. The operator may be provided with the task 133 of installing drywall. While the operator may not be able to see the components behind the drywall while the drywall impedes the view of the operator, the internal components of the wall may be augmented in the environment such that the operator can install the drywall by drilling screws into studs (without hitting electrical wiring or conduit). The operator may specify or customize the internal components for which he or she would like to see when installing the drywall. For instance, the operator may desire to see the studs while not seeing insulation.

The augmented reality system can use dimensions from the existing surfaces in a room to overlay level lines and highlight areas that are off level and help level up walls, windows, doors and other items as can be appreciated. The augmented reality system can use dimensions from an existing surface to follow a contour and use this information to transfer an overlay onto a piece that required cutting to match the contour and example of this would be mating wood trim together and cutting in the contours of an existing piece. The portion that requires cutting may have a highlighted overlay showing the contoured geometry from the mating piece and highlight the area of material to be removed. Another example may include laying out and mitering crown molding around cabinets (e.g., the top of cabinets).

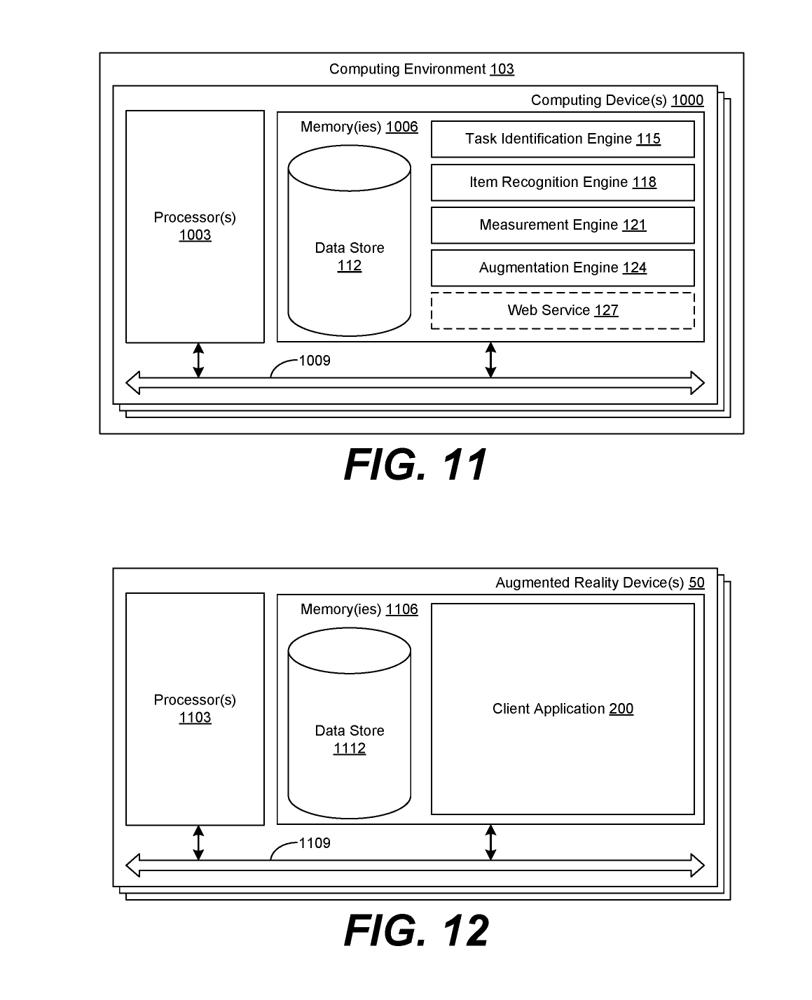

With reference to FIG. 11, shown is a schematic block diagram of the computing environment 103 according to an embodiment of the present disclosure. The computing environment 103 includes one or more computing devices 1000. Each computing device 1000 includes at least one processor circuit, for example, having a processor 1003 and a memory 1006, both of which are coupled to a local interface 1009. To this end, each computing device 1000 may comprise, for example, at least one server computer or like device. The local interface 1009 may comprise, for example, a data bus with an accompanying address/control bus or other bus structure as can be appreciated.

Stored in the memory 1006 are both data and several components that are executable by the processor 1003. In particular, stored in the memory 1006 and executable by the processor 1003 are the task identification engine 115, the item recognition engine 118, the measurement engine 121, the augmentation engine 124, and potentially other applications. Also stored in the memory 1006 may be a data store 112 and other data. In addition, an operating system may be stored in the memory 1006 and executable by the processor 1003.

With reference to FIG. 12, shown is a schematic block diagram of the augmented reality device 50 according to an embodiment of the present disclosure. The augmented reality device 50 includes at least one processor circuit, for example, having a processor 1103 and a memory 1106, both of which are coupled to a local interface 1109. The local interface 1109 may comprise, for example, a data bus with an accompanying address/control bus or other bus structure as can be appreciated.

Stored in the memory 1106 are both data and several components that are executable by the processor 1103. In particular, stored in the memory 1106 and executable by the processor 1103 is a client application 200, and potentially other applications. Also stored in the memory 1106 may be a local data store 1112 and other data. In addition, an operating system may be stored in the memory 1106 and executable by the processor 1103.

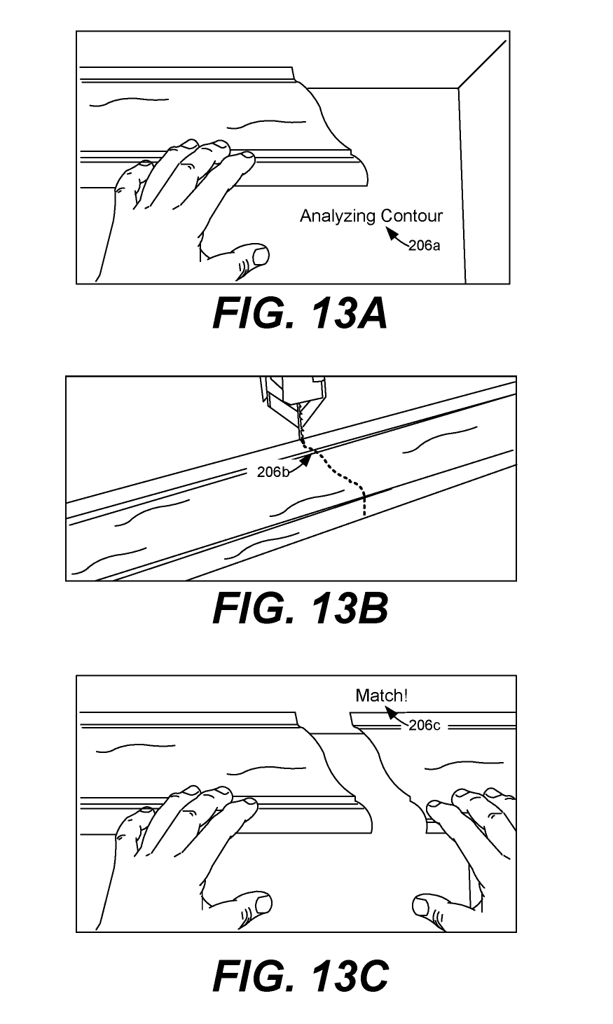

With reference to FIGS. 13A-13C, the augmented reality system can identify dimensions or contours of an existing surface to follow to transfer an overlay onto a piece that requires cutting to match the contour. For instance, as shown in FIG. 13B, the contour determined from FIG. 13A can be overlaid on the material shown and cut according to the contour. In other examples, a complementary contour (or complementary angle) may be determined based on a desired mating of the two components (e.g., 90 degree or other angle). As shown in FIG. 13C, the wood trim may be pieced together. The portion that requires cutting may have a highlighted overlay showing the contoured geometry from the mating piece and highlight the area of material to be removed.

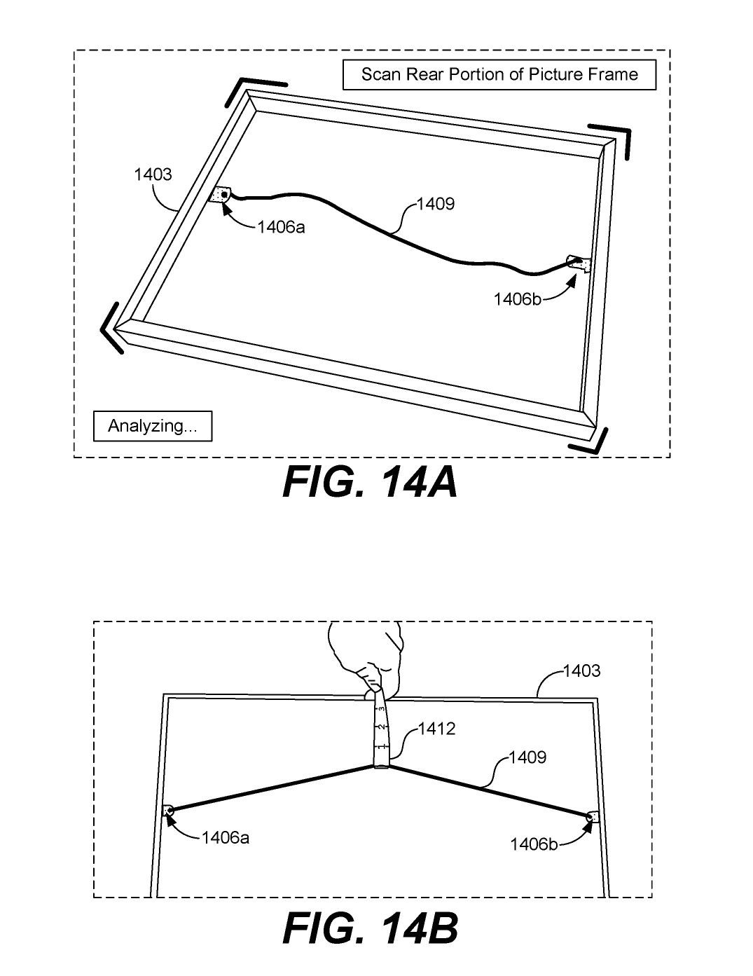

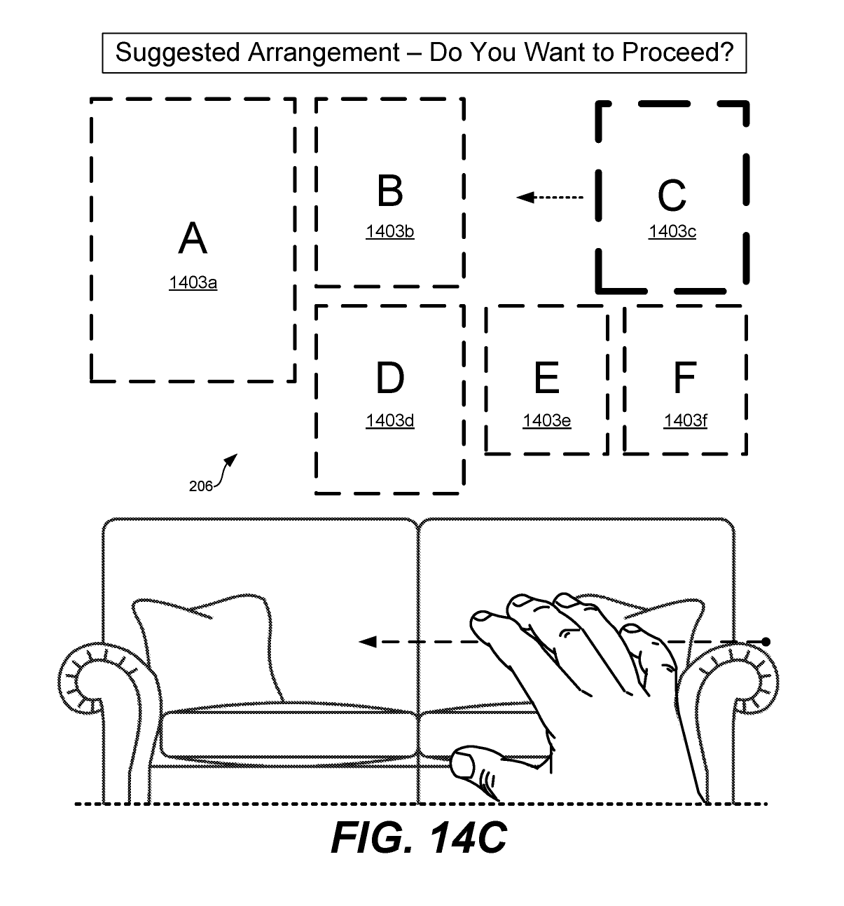

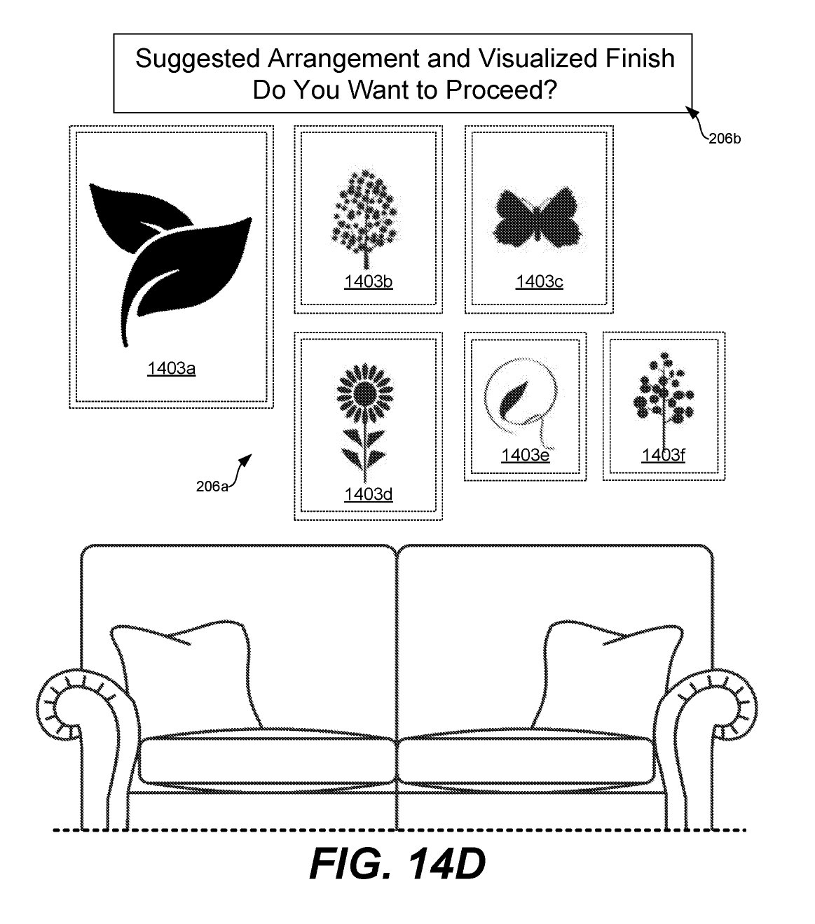

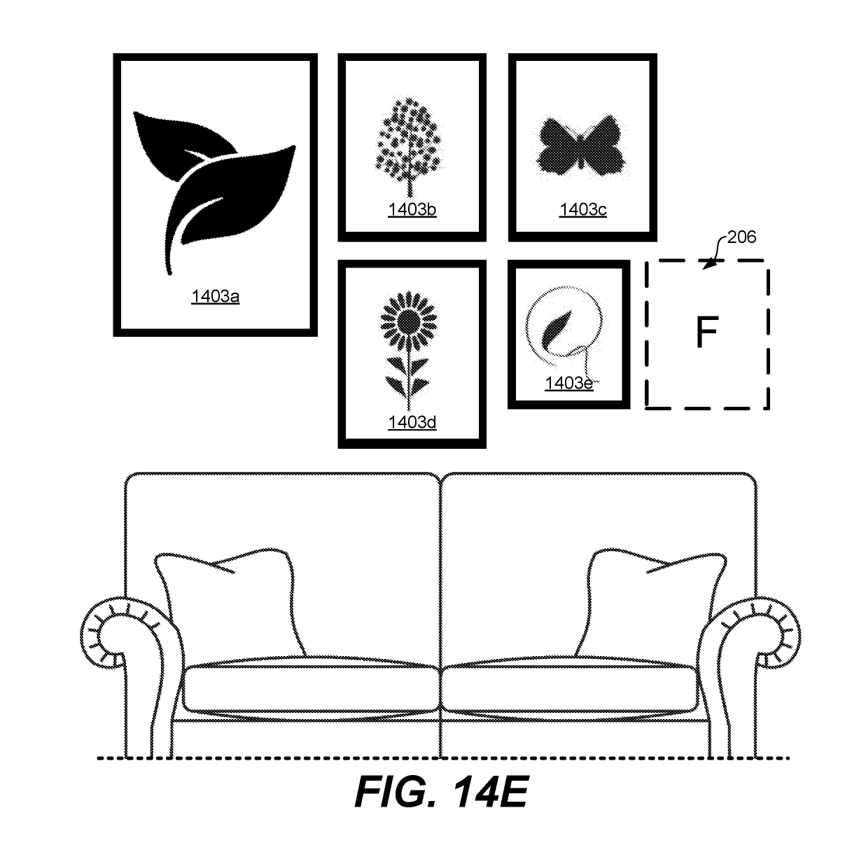

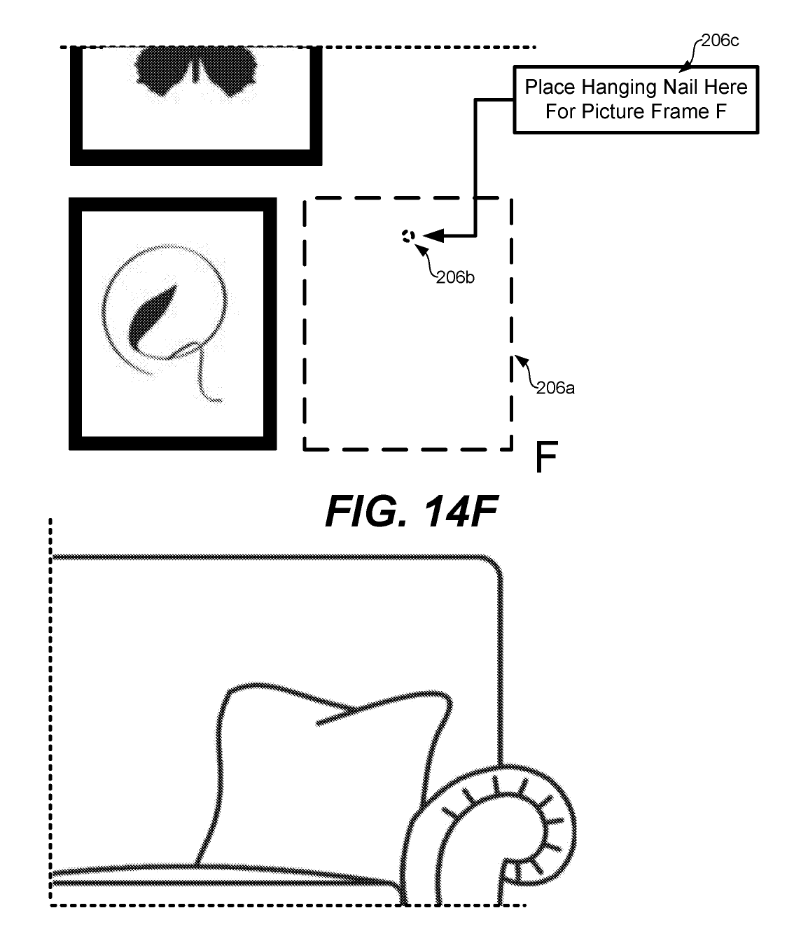

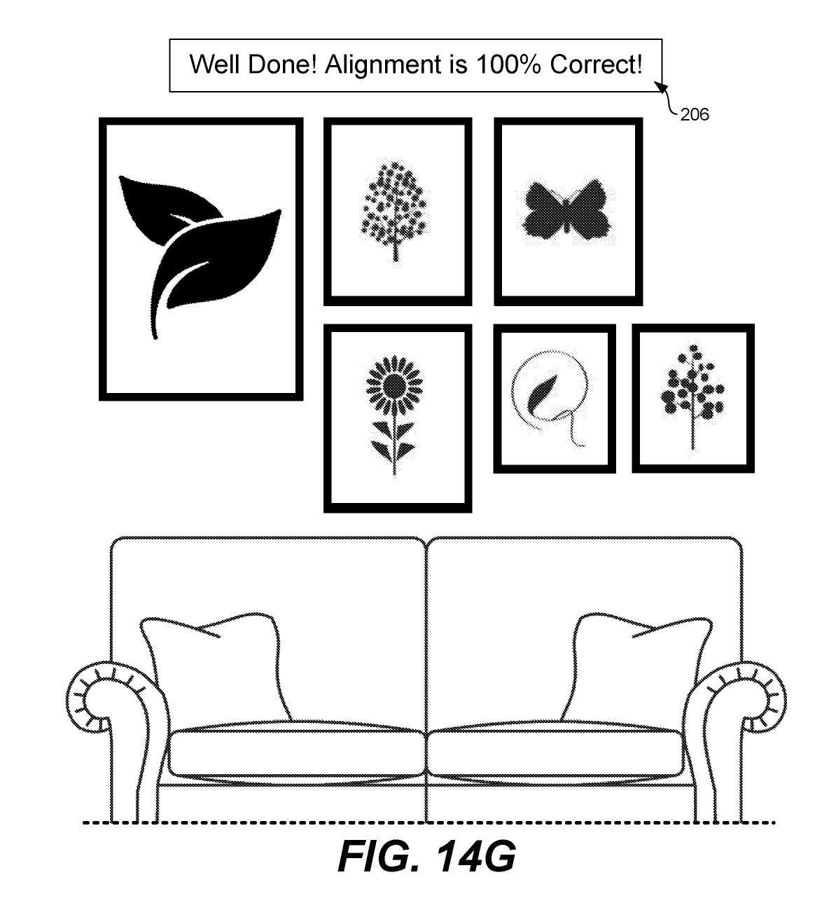

Moving on to FIGS. 14A-14G, an augmented reality session is shown where the augmented reality system is employed to hang one or more picture frames 1403. The picture frames 1403 may include artwork, photographs, mirrors, or other items. In a home, office, or public area it is common to have pictures of family, nature, mirrors, or other images. The picture frames 1403 are normally hung on the wall with a nail, screw, hook, wire, bracket, or other item. Traditionally, hanging a picture frame 1403 or other item on the wall may require a level to make sure the frame is not crooked; a tape measurer to measure a distance from a floor, ceiling, or other object; and a pen or pencil to mark the wall. Additionally, nails, screws, drywall anchors, brackets, and other materials may be required. Hanging multiple framed pictures or artwork may present additional challenges. For instance, spacing must be provided between each picture frame 1403 to appear uniform and aesthetically pleasing. Ensuring a proper spacing is especially difficult when multiple picture frames 1403 are hung having different dimensions.

Starting with FIG. 14A, prior to starting a project where one or more picture frames 1403 are hung, the operator may customize various aspects of the project, such as customizing placement of the one or more picture frames 1403 on a wall. To this end, the augmented reality system may collect information about a wall or other environment where the one or more picture frames 1403 are to be hung as well as information about the one or more picture frames 1403. For instance, the augmented reality system may instruct the operator to face a wall where one or more picture frames 1403 are to be hung to obtain the dimensions of the wall, dimensions of empty spaces on the wall, or dimensions of existing picture frames 1403 or other objects already on the wall or in the room. The camera of the eyeglasses or other device may obtain images that can be processed programmatically using the augmented reality system.

Thereafter, the augmented reality system may instruct the operator to scan a front and a rear portion of one or more picture frames 1403, as shown in FIG. 14A. During the scan, the augmented reality system may obtain dimensions of each picture frame 1403, including a height, width, depth, as well as a three-dimensional position of hooks or tabs 1406a . . . 1406b, the presence of a wire 1409, etc. Additionally, the augmented reality system may identify a subject of the picture frame 1403 by analyzing a front of the picture frame 1403, such as a piece of art or a photograph shown on the front of the picture frame which may be used in rendering a virtualization of a completed project to allow the operator to visualize the completed project, as will be discussed.

In some embodiments, the augmented reality system may have difficulty in programmatically obtaining a length of the wire 1409, especially when it is in a slack state, as shown in FIG. 14A. To this end, as shown in FIG. 14B, the augmented reality system may require the operator to pull the wire 1409 taught using a tape measure, a finger, hook, wire, string, or other object. While the example of FIG. 14B shows the operator using a tape measurer 1412, it is understood that the augmented reality system may programmatically determine a distance from a top of the picture frame to a top of the taught wire. Additionally, the augmented reality device 50 may locate a top center of a frame and indicate if the wire is pulled to the center. Similarly, the augmented reality device 50 may account for the wire being pulled crooked and calculate center location.

In various embodiments, the augmented reality system may present tasks 133 that guides an operator to hang the one or more picture frames 1403 on an area of a wall. Given the size of the one or more picture frames 1403, as well as a size of an empty area on a wall, the augmented reality system may present various layouts of the picture frames on the wall, as shown in FIG. 14C. The augmented reality system may allow the operator to switch between suggested layouts and may allow the operator to further customize a suggested layout. For instance, a plurality of picture frames 1403a . . . 1403f are shown in FIG. 14C, where the operator has selected a picture frame 1403c to relocate the picture frame 1403c to another area of the wall. For instance, the operator may move his or her hand to the left, or apply another appropriate gesture, to move the picture frame 1403c to the left. In another embodiment, an operator of the augmented reality device 50 may use his or her hand to grab and drag an augmented feature 206, such as an image, to expand or contract the spacing. In additional embodiments, the operator may use a smart phone, tablet, or other device by tapping the screen and dragging an augmented feature 206 to adjust the spacing. Regardless, the level and square orientation of the augmented features 206 may be maintained.

FIG. 14D shows a virtualization of the suggested arrangement as customized by the operator using the gesture shown in FIG. 14C. Additionally, the images of the picture frames 1403 obtained from scanning a front portion of the picture frames 1403 may be shown in the augmented reality session as augmented features 206. In some embodiments, the picture frames 1403 are virtualized with a predefined transparency setting. In additional embodiments, the virtualization may allow the operator to customize a color of the wall as well as a color of various components of the picture frames 1403, such as a matte, lining, fillet, or frame color. In some examples, an image may be generated that shows what the operator is seeing, such as an image of the environment modified to further include the augmented features 206. Thus, the image may be shared by the operator with other individuals regardless of their access to the augmented reality system. For instance, the operator may share the arrangement electronically with his or her spouse, friend, or other individual.

After determining an arrangement of the picture frames 1403, the augmented reality system may identify and present tasks 233 to the operator to perform to hang each of the picture frames 1403 in accordance with the arrangement selected by the operator. With respect to this example project, the tasks 233 may include installing wire 1409 in a picture frame 1403, adjusting the wire 1409 on the picture frame 1403 (e.g., loosening or tightening the wire 1409), attaching Velcro® or other hanging attachment to the picture frame 1403 or the wall, installing one or more dry wall anchors, nails, screws, or other items on the wall, or performing similar tasks 233, as may be appreciated. The augmented reality device 50 may facilitate the purchase of the attachments or other necessary materials, as may be appreciated.

In further embodiments, the augmented reality system may provide suggestions on the most aesthetically pleasing configuration of multiple images, pictures, artwork, or mirrors. To this end, the augmented reality system may access arrangements from the Internet to provide suggestions based on how other individuals or style experts are displaying similar style frames, artwork, or mirrors. The operator may select one of the many different arrangements and configurations or select each frame, artwork, picture or image, and virtually place it on a wall to see how it appears in an environment. Also, the operator may place an outline representing the outside dimensions of a picture frame 1403 on a wall as an augmented feature 206 before a real piece is hung on the wall. In some embodiments, the augmented reality system may automatically level, center, and space each image or picture frame 1403, such that an end arrangement is aesthetically pleasing. Once the desired position or arrangement is specified by the operator, a proper location for a nail, screw, wire, bracket, or other item may be shown on the picture frame 1403 or the wall as an augmented feature 206. After a picture frame 1403 is attached to the wall, the augmented reality system may show a level line or a grid as an augmented feature 206 of the environment to ensure proper spacing and alignment.

In some embodiments, the augmented reality system may identify colors and other characteristics of a room or environment to make recommendations for frames, mattes, fillets, liners, artwork, or other items, and facilitate a purchase corresponding real and physical products. In additional embodiments, the operator may set a location and an item for all to see or individual users can use the same target and display photos, images, video, or artwork that matches their own personal preference.

A partially completed project is shown in FIG. 14E, where nearly all of the picture frames 1403a . . . 1403e have been hung on the wall and only a single augmented feature 206 is now shown for placement of the final picture frame 1403f. For illustration purposes, FIGS. 14E-14G walk through an example of tasks 233 provided to the operator to hang a picture frame 1403, such as the final picture frame 1403f in the arrangement. For instance, in FIG. 14F, an augmented feature 206a may include a border showing the dimensions of the picture frame 1403f to be hung on a specific portion of the wall in accordance with the arrangement selected by the operator. Another augmented feature 206b may include a circle or other identifier placed in a respective portion of the wall such that the picture frame 1403f will be level, centered, and spaced appropriately and in accordance with the arrangement. The location may be determined using a measurement of the wire 1409 when taught, or a location of a hook or bracket, as may be appreciated. Additionally, an augmented feature 206b may include instructions for a current task 233 to be performed by the operator, such as placing a hanging nail for the final picture frame 1406f in the area of the augmented feature 206b.

Once the nail or other attachment is placed on the wall, a subsequent task 233 may include placing the picture frame 1403f on the wall and aligning the picture frame 1403f with the augmented feature 206a and verifying that the picture frame 1403f is level, centered, and spaced appropriately and in accordance with the arrangement, as shown in FIG. 14G. If the tasks 233 have been performed correctly, an augmented feature 206 in FIG. 14G may include notifying the operator that the alignment is correct as well as providing the operator with a metric indicating a degree to which the actual arrangement corresponds to the initial arrangement. If the operator is not satisfied with the metric, the operator may be presented with additional tasks 233 to perform to remedy the arrangement and improve the metric until satisfactory.

While the example shown in FIGS. 14A-14G pertain to hanging picture frames 1403, it is understood that the augmented reality system may assist in performing similar tasks, such as centering and applying wall paper, wall decals, mirrors, posters, shelving, or other items that may require precise placement on a wall for functional or aesthetic purposes.

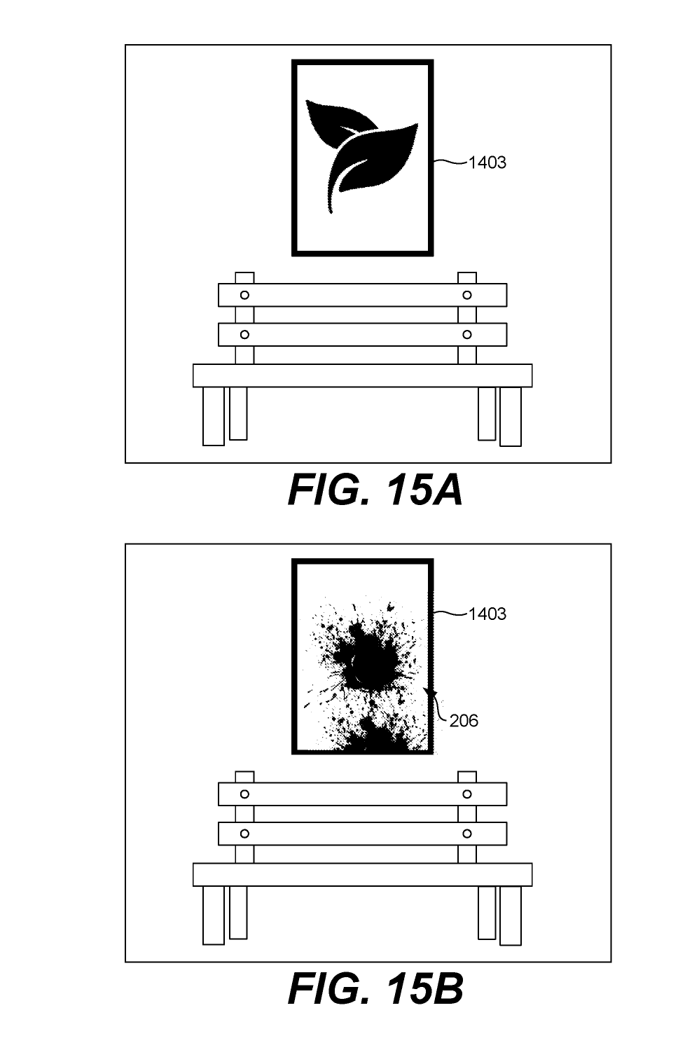

With respect to the content of artwork included in a picture frame 1403 or in another region of an environment, the subject or the content of the artwork may not be the taste of every individual in a household, office, or public area. To this end, in some embodiments, an augmented reality session may replace an image or artwork shown in a picture frame 1403 (or other region of an environment) by augmenting the area with something that would be more appealing to the operator. For example, the augmented reality system may identify a region of a frame 1403 that includes artwork, and may overlay an augmented feature 206 in the augmented reality environment to replace the artwork, as shown in FIGS. 15A and 15B.

For example, a real, physical piece of artwork might include a statue, sculpture, or nature photography, as shown in FIG. 15A. In FIG. 15B, however, an augmented feature 206 can be used to replace the content of the picture frame 1403 with an abstract piece of artwork. In some embodiments, the augmented feature 206 that replaces the content of the picture frame 1403 (or other region) may be selected from images taken by the individual (e.g., camera on his or her smartphone, augmented reality device, or other device), downloaded from the Internet, or downloaded from a cloud-based photo service.

Additionally each operator may select a different picture, image, or artwork that would be seen in the target area or other areas such that, when the operator returns to the area, the image is automatically replaced with the augmented feature 206. Additionally, artwork may selected and replaced as often as an operator desires. For instance, the operator may select a region in a room or other environment to randomly select artwork to appear as an augmented feature 206. The artwork may be selected based on the interests of the operator, or based on a particular artist, genre, etc. In some embodiments, images, pictures, or artwork that are displayed may be augmented to replace or augment the content with video or animation. Additionally, audio may be played through a speaker of the augmented reality device 50, or nearby network-enabled device, as the user is near or looking at the artwork or an augmented feature 206. For example music could be playing from the era of the artist (or other music could be selected by the operator or an administrator of the augmented feature 206 that helps them appreciate the art. A museum curator could begin speaking about the piece describing the artwork, artist, or providing other educational information about the region or era of the artist.

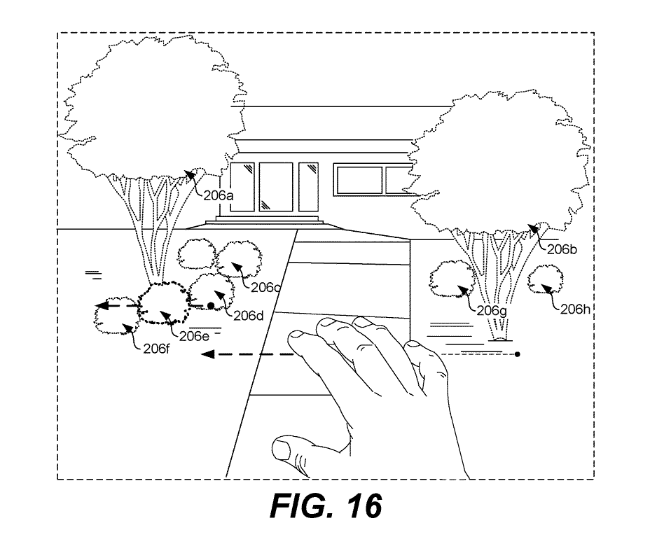

Referring next to FIG. 16, in another embodiment, the spacing and centering may be implemented in landscaping projections as well as similar projects that require centering and spacing tasks, as can be appreciated. For example, an operator may utilize the augmented reality device 50 to plant flowers, bushes, trees, or other plants, lay mulch, or visualize a completed landscaping project in accordance with ideal landscaping arrangements or guidelines. The augmented reality device 50 may augment an environment to include augmented features 206a . . . 206h of fully grown plants, trees, bushes, flowers, stones, grass, or other landscaping features relative to a specified region, a house, or other fixture to help determine proper orientations, arrangements, and spacing for landscaping features. Additionally, the augmented reality device 50 may measure an amount of space to center each augmented features 206 relative to a surrounding space or region. The augmented reality device 50 may show what a plant, tree, bush, flower, stone, or other landscaping feature will look like in its location, as well as provide one or more views of a size of a plant during its various sizes of growth. To this end, the item catalog 142 stored in memory may include images or three-dimensional renderings of various landscaping features, such as plants, trees, bushes, flowers, stones, grass, lawn ornaments, etc., where the augmented reality device 50 may impose the images or the three-dimensional renderings in the environment.

The augmented reality device 50 may use the camera to identify objects (e.g., a house, an existing tree providing shade, or other item) as well as a GPS module to determine a region and orientation to make plant, tree, bush, or other landscaping recommendations for that particular location (e.g., full sun, part sun or shade). Additionally, the augmented reality device 50 may facilitate trimming plants or other landscaping features.

It is understood that there may be other applications that are stored in the memory 1006/1106 and are executable by the processor 1003/1103 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 1006/1106 and are executable by the processor 1003/1103. In this respect, the term “executable” means a program file that is in a form that can ultimately be run by the processor 1003/1103. Examples of executable programs may be, for example, a compiled program that can be translated into machine code in a format that can be loaded into a random access portion of the memory 1006/1106 and run by the processor 1003/1103, source code that may be expressed in proper format such as object code that is capable of being loaded into a random access portion of the memory 1006/1106 and executed by the processor 1003/1103, or source code that may be interpreted by another executable program to generate instructions in a random access portion of the memory 1006/1106 to be executed by the processor 1003/1103, etc. An executable program may be stored in any portion or component of the memory 1006/1106 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 1006 is defined herein as including both volatile and nonvolatile memory and data storage components. Volatile components are those that do not retain data values upon loss of power. Nonvolatile components are those that retain data upon a loss of power. Thus, the memory 1006 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 1003/1103 may represent multiple processors 1003/1103 and/or multiple processor cores and the memory 1006/1106 may represent multiple memories 1006/1106 that operate in parallel processing circuits, respectively. In such a case, the local interface 1009/1109 may be an appropriate network that facilitates communication between any two of the multiple processors 1003/1103, between any processor 1003/1103 and any of the memories 1006/1106, or between any two of the memories 1006/1106, etc. The local interface 1009/1109 may comprise additional systems designed to coordinate this communication, including, for example, performing load balancing. The processor 1003/1103 may be of electrical or of some other available construction.

Although the task identification engine 115, the item recognition engine 118, the measurement engine 121, the augmentation engine 124, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart of FIG. 9 shows the functionality and operation of an implementation of portions of the task identification engine 115, the item recognition engine 118, the measurement engine 121, and the augmentation engine 124. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 1003/1103 in a computer system or other system. The machine code may be converted from the source code, etc. If embodied in hardware, each block may represent a circuit or a number of interconnected circuits to implement the specified logical function(s).

Although the flowchart of FIG. 9 shows a specific order of execution, it is understood that the order of execution may differ from that which is depicted. For example, the order of execution of two or more blocks may be scrambled relative to the order shown. Also, two or more blocks shown in succession in FIG. 9 may be executed concurrently or with partial concurrence. Further, in some embodiments, one or more of the blocks shown in FIG. 9 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the task identification engine 115, the item recognition engine 118, the measurement engine 121, and the augmentation engine 124, that comprises software or code can be embodied in any non-transitory computer-readable medium for use by or in connection with an instruction execution system such as, for example, a processor 1003 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the task identification engine 115, the item recognition engine 118, the measurement engine 121, and the augmentation engine 124, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 1000, or in multiple computing devices in the same computing environment 103. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure.

Therefore, the following is claimed:

1. A system, comprising:
an augmented reality device comprising a camera, a display, a network interface, and at least one hardware processor;
program instructions executable by the at least one hardware processor that, when executed, cause the at least one hardware processor to:
generate an augmented reality session for an environment where video data is captured using the camera and provided to a computing environment for analysis;
receive, through gesture or voice recognition during the augmented reality session, a specification of a project to perform in the environment and at least one parameter for the project;
perform at least one measurement in the environment using at least one reference object identified in the augmented reality session;
augment the environment in the augmented reality session by imposing a visualization of a completed form of the project, the visualization generated using the at least one parameter and the at least one measurement;
query, using the network interface, a data store to identify a plurality of tasks to perform in completion of the project; and sequentially display data for each of the plurality of tasks in the display of the augmented reality device, wherein a completion of one of the plurality of tasks prompts a transition to a subsequent one of the plurality of tasks.

2. The system of claim 1, further comprising program instructions that, when executed, cause the at least one computing device to determine that the project specified is one of a plurality of available projects having data stored in the data store.

3. The system of claim 1, further comprising program instructions that, when executed, cause the at least one computing device to augment the environment in the augmented reality session by:
overlaying a visualization of a completed task for the project;
overlaying a hologram of a square or a ruler in an environment; or
overlaying a graphic or text indicating whether an object is level or square in the environment.

4. The system of claim 1, further comprising program instructions that, when executed, cause the at least one computing device to:
programmatically identify at least one item to cut in an environment; and
overlay a virtual cut line on the at least one item.

5. The system of claim 1, wherein augmenting the environment in the augmented reality session by imposing the visualization of the completed form of the project further comprises:
generating the visualization using at least one representative image for the project;
modifying the at least one representative image such that the visualization of the project conforms to the environment; and
generating augmented reality data that virtually imposes the at least one representative image in the environment during the augmented reality session.

6. The system of claim 1, further comprising program instructions that, when executed, cause the at least one computing device to programmatically inspect a modified item to determine that one of the plurality of tasks has been satisfactorily performed.

7. The system of claim 6, wherein, in response to the one of the plurality of tasks having not been satisfactorily performed, determine a remedial action for an operator of the augmented reality device to perform to complete the one of the plurality of tasks.

8. The system of claim 1, further comprising program instructions that, when executed, cause the at least one computing device to:
impose a visualization of an item in a region of the environment;
identify a voice command or a hand gesture being performed; and
in response to the voice command or the hand gesture being identified, cause a transition of the item to another item in the region of the environment.

9. The system of claim 1, further comprising program instructions that, when executed, cause the at least one computing device to:
generate a bill of materials for the project using the at least one parameter and the at least one measurement;
display the bill of materials for the project in the display; and
verify that the bill of materials has been gathered for the project.

10. The system of claim 9, wherein verifying that the bill of materials has been gathered for the project further comprises detecting each of a plurality of items in the bill of materials during the augmented reality session.

11. A computer-implement method, comprising:
generating, by an augmented reality device that comprises at least one hardware processor, an augmented reality session for an environment where video data is captured using a camera and provided to a computing environment for analysis;
receiving, through gesture or voice recognition during the augmented reality session, a specification of a project to perform in the environment and at least one parameter for the project;
performing, by the augmented reality device, at least one measurement in the environment using at least one reference object identified in the augmented reality session;
augmenting, by the augmented reality device, the environment in the augmented reality session by imposing a visualization of a completed form of the project, the visualization generated using the at least one parameter and the at least one measurement;
querying, by the augmented reality device, a data store to identify a plurality of tasks to perform in completion of the project using a network interface; and
sequentially displaying, by the augmented reality device, data for each of the plurality of tasks in the display of the augmented reality device, wherein a completion of one of the plurality of tasks prompts a transition to a subsequent one of the plurality of tasks.

12. The computer-implemented method of claim 11, further comprising determining, by the augmented reality device, that the project specified is one of a plurality of available projects having data stored in the data store.

13. The computer-implemented method of claim 11, further comprising:
augmenting, by the augmented reality device, the environment in the augmented reality session by imposing a visualization of a completed task for the project;
overlaying, by the augmented reality device, a hologram of a square or a ruler in the environment; or
overlaying, by the augmented reality device, a graphic or text indicating whether an object is level or square in the environment.

14. The computer-implemented method of claim 11, further comprising:
programmatically identifying, by the augmented reality device, at least one item to cut in an environment; and
overlaying, by the augmented reality device, a virtual cut line on the at least one item.

15. The computer-implemented method of claim 11, wherein augmenting the environment in the augmented reality session by imposing the visualization of the completed form of the project further comprises:
generating, by the augmented reality device, the visualization using at least one representative image for the project;
modifying, by the augmented reality device, the at least one representative image such that the visualization of the project conforms to the environment; and
generating, by the augmented reality device, augmented reality data that virtually imposes the at least one representative image in the environment during the augmented reality session.

16. The computer-implemented method of claim 11, further comprising programmatically inspecting, by the augmented reality device, a modified item to determine that one of the plurality of tasks has been satisfactorily performed.

17. The computer-implemented method of claim 16, further comprising, in response to the one of the plurality of tasks having not been satisfactorily performed, determining, by the augmented reality device, a remedial action for an operator of the augmented reality device to perform to complete the one of the plurality of tasks.

18. The computer-implemented method of claim 11, further comprising:
imposing, by the augmented reality device, a visualization of an item in a region of the environment;
identifying, by the augmented reality device, a voice command or a hand gesture being performed; and
in response to the voice command or the hand gesture being identified, causing, by the augmented reality device, a transition of the item to another item in the region of the environment.

19. The computer-implemented method of claim 11, further comprising:
generating, by the augmented reality device, a bill of materials for the project using the at least one parameter and the at least one measurement;
displaying, by the augmented reality device, the bill of materials for the project in the display; and
verifying, by the augmented reality device, that the bill of materials has been gathered for the project.

20. The computer-implemented method of claim 19, wherein verifying that the bill of materials has been gathered for the project further comprises detecting, by the augmented reality device, each of a plurality of items in the bill of materials during the augmented reality session.
